(19) United States
(12) Patent Application Publication
(10) Pub. No.: US 2014/0209803 A1
(43) Pub. Date: Jul. 31, 2014

(54) METHODS, ELECTRICAL POWER CONTROL SYSTEM, AND POWER CONTROL CIRCUIT FOR MAINTAINING OR PROVIDING CONSTANT OR SUBSTANTIALLY CONSTANT POWER, FOR REDUCING AND/OR MINIMIZING POWER DECAY, AND FOR IMPROVING AN INFRARED SOURCE DRIVER, AND METHODS OF USING SAME

(71) Applicant: FTRX LLC, Deer Park, NY (US)

(72) Inventors: Mark Edward Hamberger, Bay Shore, NY (US); Alexander Gerson Jacobson, Hollywood, FL (US); Drouét Warren Vidrine, San Clemente, CA (US); Jack Gordon Kisslinger, Madison, WI (US)

(73) Assignee: FTRX LLC, Deer Park, NY (US)

(21) Appl. No.: 14/090,457

(22) Filed: Nov. 26, 2013

Related U.S. Application Data
(60) Provisional application No. 61/730,602, filed on Nov. 28, 2012.

(51) Int. Cl. G05F 1/46; G01J 3/28

(52) U.S. Cl. CPC G05F 1/46; G01J 3/28
USPC 250/339.08; 323/234

(57) ABSTRACT

A power system, power circuit, and methods for maintaining or providing a constant or substantially constant power source and for reducing and/or minimizing power decay of a predetermined component are provided. Such improvement of power delivery and minimization of power loss is important for precision instrumentation applications. One such application is the infrared (“IR”) source driver for a Fourier Transform Infrared Spectrometer (“FTIR”). The power system and/or circuit may include two integrated circuits in a novel way to make an efficient constant power IR source driver. The method may include having a switching regulator comparing a sample of output voltage with a reference voltage, a second element computing, calculating and/or creating a voltage that is a product of another voltage and a current to obtain a signal proportional to delivered power, and operating a closed loop regulator to provide a constant delivered power to the source.

### CROSS-REFERENCE TO RELATED APPLICATION(S)

This application is a non-provisional patent application that claims the benefit of the filing date of, and priority to, U.S. Provisional Application No. 61/730,602, filed Nov. 28, 2012, the entirety of which is incorporated herein by reference.

### FIELD OF THE INVENTION

The present invention is in the field of mechanisms, including electrical circuits, for maintaining or providing a constant or substantially constant power to a predetermined electrical component, for reducing and/or minimizing power decay within power sources and/or electrical components, and for improving an infrared source driver or a power source in general. Such improvement of power delivery and minimization of power loss is important for precision instrumentation applications. One such application is the infrared (“IR”) source driver for optical instruments, and in particular infrared Spectrometers such as Fourier Transform Infrared Spectrometers (“FTIRs”).

### BACKGROUND OF THE INVENTION

FTIRs are well known in the art. Michelson interferometers function by splitting a beam of electromagnetic radiation into two separate beams via a beam splitter. Each beam travels along its own path, e.g., a reference path of fixed length and a measurement path of variable length. A reflecting element, such as a retroreflector, is placed in the path of each beam and returns both beams to the beam splitter. The beams are there recombined into a two exit beams. The variable path length causes the combined exit beams to be amplitude modulated due to interference between the fixed and variable length beams. One exit beam of the two exit beams may typically return towards the source, and in one or more designs may not used, although it contains practical information, and in one or more other designs may be used for such practical information. By analyzing the second exit beam, propagating away from the source, the spectrum of the input radiation may, after suitable calibration and calculation, be derived as a function of frequency.

When the above interferometer is employed in an FTIR Spectrometer, the used exit beam or exit beams are focused upon a detector. If a sample is placed such that the modulated beam passes through it prior to impinging upon the detector, the analysis performed can determine the absorption spectrum of the sample. The sample may also be placed otherwise in the arrangement to obtain other characteristics.

Silicon carbide and silicon carbide ceramics have long been used as an infrared (IR) source in Spectrometers. Preferably, in one or more applications, the IR source is bright and stable over one or more long periods of time, at a predetermined, constant temperature. However, it has been observed that the brightness of silicon carbide and silicon carbide ceramic sources decays rapidly over time when driven at constant voltage. The reason for the decay has been traced to an increase in electrical resistance over time. Since the electrical power delivered to the IR source at a constant voltage depends inversely on resistance, power delivered to the source also decays over time. Unless corrected by some means, an inferior mode of operation of the Spectrometer results because a reduction in source power reduces the signal level in the Spectrometer, thereby reducing the signal to noise ratio of the Spectrometer.

An unsatisfactory solution that has been employed in the past is to use a circuit that measures the voltage applied to the source and stabilizes the voltage. This is called constant voltage operation. Unfortunately, this problem is grossly inadequate. The inadequacy is easily illustrated by the following practical example: A 12 watt IR source might have a resistance of 12 Ohms when new and 40 Ohms when old. This is illustrated by actual measurements of a source in FIG. 8. Referring to FIG. 8, when the source is operated early in its life, its resistance may be 12 Ohms. Under the “new” scenario, Ohm's law calculations (i.e., E=I*R) show that, based on the equation and aforementioned information, E=I*12 Ohms and P=E*I=12 watts. As such, when solving the equations simultaneously, E=12 volts and I=1 ampere. Later, when the source has been operated for 4000 hours, its resistance may have increased to 32 Ohms. If the voltage remains at the regulated value of 12 volts, it is shown that E×I product=power (P)=12 volts×(12 volts/32 Ohms)=4.5 watts. Thus under constant voltage operation, with the voltage adjusted such that the voltage corresponds to the voltage of a new source, the power delivered to and dissipated by the source has declined so much, i.e., by about 63%, thereby making the system unusable and/or less than optimal.

An additional unsatisfactory solution is to use a photodetector staring at the IR source. It may be easy to think that using a photodetector is an ideal solution. Unfortunately, if the photodetector ages, or if particulate matter or some other object blocks the detector, the detector may erroneously deliver a weaker signal, causing a subsequent control circuit to heat the IR source up, which can damage and/or destroy the IR source. In addition, most detectors are intrinsically thermally sensitive, and accurate detectors require their own thermal stabilization.

Constant current operation might also be considered. However, calculations similar to that in paragraph 5 above show that, as the IR source ages, the power would then actually increase. This will quickly lead to catastrophic failure of the IR source. As such, constant current operation is not a solution to the aforementioned problems.

Therefore, what is needed is an improved component or source driver circuit to provide stable and constant power to the component or IR source and to maintain the constant power, thereby reducing and/or minimizing power decay due to various mechanisms within the IR source. Such needs are felt for improving broadband light sources (i.e., a light source that radiates over a broad wavelength range; also referred to as light source/beam, radiation source, thermal source, infrared source, radiation beam, radiation/light source, and radiation/light beam) in general.

Accordingly, it would be desirable to provide a constant power circuit for use in at least one optical assembly to achieve constant, stable power over a sufficient predetermined period of time at high efficiency and a reasonable cost of manufacture and maintenance.

### SUMMARY OF THE INVENTION

Accordingly, it is a broad object of the invention to provide an electrical circuit or apparatus and a system, and methods of using same, to make an efficient, stable and constant power source driver, such as an infrared (IR) source driver.

A method of delivering or providing constant or substantially constant power may include dynamically controlling or changing at least one of a voltage and a current of a predetermined, electrical component such that an electrical power, which is at least one of provided or delivered to the predetermined component and consumed by the predetermined component, is at least one of: (i) identical or substantially similar to a predetermined, chosen or preset value of electrical power; and (ii) constant or substantially constant, thereby reducing, minimizing or eliminating power decay within the predetermined component. The dynamically controlling or changing step may further include at least one of: (i) changing only the voltage of the predetermined, electrical component while keeping the current of the predetermined, electrical component constant in response to the changing resistance of the predetermined, electrical component; (ii) changing only the current of the predetermined, electrical component while keeping the voltage of the predetermined, electrical component constant in response to the changing resistance of the predetermined, electrical component; and (iii) changing a combination of the voltage of the predetermined, electrical component and the current of the predetermined, electrical component in response to the changing resistance of the predetermined, electrical component. The predetermined, chosen or preset value of electrical power may be at least one of: a preset value of electrical power that the predetermined component consumes to operate; a preset value of electrical power that the predetermined component needs to operate; a value of electrical power that a user of the predetermined component has set for the predetermined component; a factory or manufactured setting of electrical power at which the predetermined component is designed to operate; and a value of electrical power to be constantly maintained and achieved for at least one of delivery to and use by the predetermined component.

The predetermined, electrical component may have a resistance that operates to change over time, thereby requiring the dynamic control or change of at least one of the voltage and the current of the predetermined component to provide or deliver constant or substantially constant power. The voltage of the predetermined, electrical component may operate to be dynamic, varied or changed in response to the changing resistance of the predetermined, electrical component. The voltage of the predetermined, electrical component may be varied or changed using the equation V=square root (“sqrt”) of the product of power and resistance (P*R), where V is voltage, P is the predetermined, chosen or preset value of electrical power and R is the varying or changing resistance of the predetermined, electrical component. The current of the predetermined, electrical component may operate to be dynamic, varied or changed in response to the changing resistance of the predetermined, electrical component. The current of the predetermined, electrical component may be varied or changed using the equation I=sqrt (P/R), where I is current, P is the predetermined, chosen or preset value of electrical power and R is the varying or changing resistance of the predetermined, electrical component. The resistance of the predetermined, electrical component may change as a function of the amount of time that the predetermined, electrical component is used or operated. In at least one embodiment, the predetermined, electrical component may include at least one of: a broadband thermal infrared source, a radiation source, an infrared source, a broadband light source, a light source that radiates on a broadband wavelength, a light source or device for producing a light beam, a thermal source, and a device for producing a radiation beam. The electrical power that is at least one of delivered to and consumed by the predetermined, electrical component may originate from a power source.

The one or more methods may further include: (i) determining at least one of the electrical power at least one of consumed by and delivered or provided to the predetermined component and a value proportional to the electrical power at least one of consumed by and delivered or provided to the predetermined component by multiplying and obtaining a product of at least two signals, wherein: a first signal of the at least two signals at least one of represents and is proportional to the voltage of the predetermined component and a second signal of the at least two signals at least one of represents and is proportional to the current of the predetermined component; (ii) comparing at least one of the determined at least one of consumed and delivered electrical power and the determined multiplication product representing the at least one of consumed and delivered electrical power with the predetermined, chosen or preset value of electrical power; and (iii) adjusting, maintaining, creating or producing at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to the predetermined, chosen or preset value of electrical power; and constant or substantially constant. The determining, comparing and adjusting, maintaining, creating or producing steps may be performed in a closed-loop control circuit and/or system, and/or may be performed continuously and repeatedly while the predetermined component is operating.

The methods may further include at least one of: (i) computing, calculating and/or creating at least one of: (a) the voltage of the predetermined component; (b) a voltage that is proportional to the electrical power that is at least one of consumed by and delivered to the predetermined component; (c) the current of the predetermined component; (d) a current that is proportional to the electrical power that is at least one of consumed by and delivered to the predetermined component; (e) the first signal of the at least two signals; and (f) the second signal of the at least two signals; (ii) obtaining or receiving the predetermined, chosen or preset value of the electrical power from at least one of a processor and a database in connection with a circuit and/or system operating the method to deliver or provide the constant or substantially constant power to the predetermined component; (iii) obtaining, receiving or setting the predetermined, chosen or preset value of the electrical power using a potentiometer (“pot”) of at least one of a circuit and a system operating the method to deliver or provide the constant or substantially constant power to the predetermined component; (iv) determining at least one of: (a) whether to increase, decrease or keep constant at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; (b) if a need for an increase or decrease is determined, at least one of the amount of the increase or the decrease of at least one of: the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; and (c) the final corrected value of at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; (v) automatically adjusting, maintaining, creating or producing at least one of the voltage of the predetermined component, the current of the predetermined component, the voltage that is proportional to the electrical power that is at least one of consumed by and delivered to the predetermined component and the current that is proportional to the electrical power that is at least one of consumed by and delivered to the predetermined component in one or more increments, wherein the closed-loop operates to electrically perform the automatic maintenance, adjustment or production cyclically over time while the predetermined component is in operation; and (vi) sending at least one of the determined electrical power that is at least one of consumed by and delivered to the predetermined component, the at least two signals and the multiplication product to a control circuit or control system operating the method to deliver or provide the constant or substantially constant power to the predetermined component.

One or more further methods may further include at least one of: (i) measuring at least one of the voltage of the predetermined component and a signal proportional to the voltage of the predetermined component to obtain a first value; (ii) measuring at least one of the current of the predetermined component and a signal proportional to the current of the predetermined component; (iii) creating a voltage proportional to at least one of the current and the signal proportional to the current, the voltage proportional to at least one of the current and the signal proportional to the current having a second value; (iv) multiplying and obtaining a product of at least one of the measured voltage and the measured current and the first and second values, thereby obtaining a value that is proportional to the at least one of consumed and delivered electrical power; (v) comparing the determined value that is proportional to the at least one of consumed and delivered electrical power with the predetermined, chosen or preset value of electrical power; and (vi) adjusting, maintaining, creating or producing at least one of the current, the voltage, both the current and the voltage, and the product of the voltage times current delivered to the predetermined electrical component such that the electrical power that is at least one of delivered to and consumed by the predetermined component is at least one of: identical or substantially similar to the predetermined, chosen or preset value of electrical power; and constant or substantially constant. The measured at least one of the voltage of the predetermined component and the signal proportional to the voltage of the predetermined component may be available or stored as a digital number, and/or the measured at least one of the current of the predetermined component and the signal proportional to the current of the predetermined component may be available or stored as a second digital number. The first and second values may be converted to first and second digital numbers by at least one analog-to-digital converter (ADC). The measuring, measuring, creating, multiplying and adjusting, maintaining, creating or producing steps may be performed continuously and repeated while the predetermined component is operating.

The first and second digital numbers may be multiplied using a digital multiplier, thereby obtaining a number that is proportional to the at least one of consumed and delivered electrical power. The digital multiplier may be included in a computer or processor that operates to use the multiplied number output from the digital multiplier to perform a processing step for generating a digital-to-analog converter (DAC) command, the DAC command being transmitted to a DAC, which generates an analog output that is transmitted to a power stage, the power stage also receiving a commanded power from the processing step of the computer or processor and using the commanded power and the analog output from the DAC to perform the adjusting, maintaining, creating or producing step. The measuring, measuring, creating, multiplying and adjusting, maintaining, creating or producing steps may be performed by at least one of the computer or the processor and one or more processors or computers. The measuring voltage step may be performed by a voltage measuring circuit and the measuring current step may be performed by a current measuring circuit, and the measuring, measuring, creating, multiplying and adjusting, maintaining, creating or producing steps may be performed in a closed-loop circuit and/or system. At least one of the computer or the processor and the one or more processors or computers may execute the measuring, measuring, creating, multiplying and adjusting, maintaining, creating or producing steps by: (a) creating one or more new command numbers for one or more variables to be controlled, the one or more variables comprising at least one of: the current, the voltage, both the current and the voltage, and the product of the voltage times current delivered to the predetermined electrical component; and (b) applying the one or more new command numbers to one or more digitally responsive circuits, thereby controlling the one or more variables. The one or more digitally responsive circuits may include digital-to-analog converters (DACs) that operate to create at least one of the output voltages and the output currents.

The signals that are proportional to at least one of the voltage, the current and the at least one of consumed and delivered electrical power may be generated by at least one logarithmic amplifier and an antilogarithmic amplifier, the at least one logarithmic amplifier operating to generate a voltage proportional to log (the voltage of the predetermined component) and a voltage proportional to log (the current of the predetermined component) and to transmit the generated voltages to a summing amplifier, the summing amplifier operating to sum the two generated voltages, thereby creating a voltage proportional to the log of the current times the voltage, and the antilogarithmic amplifier operating to receive the voltage proportional to the log of the current times the voltage and to create a voltage proportional to the at least one of consumed and delivered electrical power.

In accordance with one or more aspects of the present invention, one or more power control circuits and/or systems (also referred to as a “power circuit”) for delivering or providing constant or substantially constant power are provided. It is a further purpose of this invention to produce substantially constant and stable power via a novel, unobvious circuit, especially for an IR source driver or other type of source driver. Surprisingly it has been found that uniquely combining two integrated circuits provides the solution to the aforementioned power decay problem such that substantially constant, stable power may be achieved.

One or more power control circuits and/or systems may include at least one of at least one circuit and at least one processor, at least one of the at least one circuit and the at least one processor operating to perform one or more of the aforementioned methods to dynamically control or change at least one of a voltage and a current of a predetermined, electrical component such that an electrical power, which is at least one of provided or delivered to the predetermined component and consumed by the predetermined component, is at least one of: (i) identical or substantially similar to a predetermined, chosen or preset value of electrical power; and (ii) constant or substantially constant. Preferably, the predetermined, electrical component is connected to, and communicates with, the at least one of the at least one circuit and the at least one processor, and the at least one of the at least one circuit and the at least one processor may be connected to, and in communication with, the power source operating to provide the electrical power. Preferably, the one or more power control circuits and/or systems operate in a closed-loop, and at least one of the at least one circuit and the at least one processor operate in a closed-loop. At least one of the at least one circuit and the at least one processor may operate to at least one of receive and set a new value for the predetermined, chosen or preset value of electrical power.

In one or more embodiments, the at least one of the at least one circuit and the at least one processor may further include at least one of a first circuit and a first processor and at least one of a second circuit and a second processor, wherein: (i) the at least one of the first circuit and the first processor operates to determine the at least one of consumed and delivered electrical power, to receive the at least two signals, to calculate the value proportional to the electrical power by multiplying and obtaining a product of the at least two signals, and to send at least one of the at least two signals, the multiplication product and the calculated at least one of consumed and delivered electrical power to the at least one of the second circuit and the second processor; and (ii) the at least one of the second circuit and the second processor operates to: (a) compare at least one of the determined electrical power that is at least one of consumed and delivered to the predetermined component, the at least two signals, and the determined multiplication product representing the at least one of consumed and delivered electrical power with the predetermined, chosen or preset value of electrical power; and (b) adjust, maintain, create or produce at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to a predetermined, chosen or preset value of power; and constant or substantially constant, thereby reducing, minimizing or eliminating power decay within the predetermined component. The at least one of the second circuit and the second processor may further operate to at least one of: (i) automatically and continuously repeat the comparison of the information received from the at least one of the first circuit and the first processor and the adjustment, maintenance or production of the at least one of the voltage and current of the predetermined component; and (ii) automatically and continuously repeat the comparison of the information received from the at least one of the first circuit and the first processor and the adjustment, maintenance or production of the at least one of the voltage and current of the predetermined component while the predetermined component is operational. The at least one of the at least one first circuit and the at least one first processor may include at least one of: an integrated circuit, a MAX 4210B, a MAX 4210, a MAX 4211, a computer, one or more processors, one or more microprocessors, and one or more analog-to-digital converters with one or more analog conditioning circuits, and the at least one of the at least one second circuit and the at least one second processor may include at least one of: an integrated circuit; a MAX15041, a switching regulator, and a closed-loop switching regulator, a computer, one or more processors and one or more microprocessors.

In one or more embodiments, two integrated circuits (e.g., the two commercially available integrated circuits discussed below) may be employed in a novel way to make an efficient constant power IR source driver. The first circuit, i.e., the MAX15041 or a similar circuit, may be purchased from Maxim Integrated (www.maximintegrated.com). The first circuit may be a switching regulator that may be used to regulate voltage. The MAX15041 uses synchronous DC-DC conversion to achieve good efficiency over a wide range of output voltages. The MAX 15041 is a low-cost, synchronous DC-DC converter with internal switches that can deliver an output current up to 3A. In one or more embodiments of the invention, the MAX15041 may be used as a voltage regulator where the output voltage is controlled in such a way as to regulate the power dissipated in a predetermined component, such as an IR source.

The second circuit may be a MAX 4210B or a similar circuit (e.g., the MAX 4210/MAX 4211) that may also be purchased from Maxim Integrated (www.maximintegrated.com) or other circuit discussed below or a similar circuit thereto and which outputs a voltage that is proportional to power consumed. It will be appreciated that, with advances in semiconductor circuit offerings, differing, superior or lower cost circuits, having substantially identical functions, but which may differ in internal construction, may be suitably applied to the described invention.

Typically, these types of products lack power regulation or have inefficient means of power regulation. Additionally, these products, as they are typically used, exude massive or large amounts of heat, which leads to inefficient loss of power. However, as will be described below, the combination of the aforementioned circuits, or similar circuits, will be operated to construct a constant power delivery circuit with high accuracy, and also high efficiency, where efficiency is defined as the ratio of the delivered power to the source divided by the overall electrical power delivered to the circuit powering the source. As a further novel and non-obvious aspect of this invention, the signal (e.g., such as a signal proportional to power) created by the second circuit, e.g., the MAX 4210B or a similar circuit, is sent to the first circuit, e.g., the MAX15041 or a similar circuit (e.g., a similar circuit having an efficient power stage), at the feedback terminal of the first circuit. Such a unique, non-obvious combination of integrated circuits results in the critical results of having stable, constant, substantially stable or substantially constant power output (see e.g., FIG. 9D) when facing a changing resistance over time (see e.g., FIG. 9A).

The at least one of the second circuit and the second processor may further include at least one closed-loop switching regulator to produce at least one of the varied or changed voltage and the varied or changed current to operate the predetermined component. The switching regulator or the at least one closed-loop switching regulator may include a first regulator and a second regulator, the first regulator operating to produce the varied or changed voltage and the second regulator operating to produce the varied or changed current. The first regulator may be at least one of: a voltage regulator, a voltage switching regulator, a voltage regulator with an operational amplifier (“op amp”), a transistor regulator, silicon controlled rectifiers (“SCR”), a voltage stabilizer and the MAX15041. The first regulator may operate to employ synchronous DC-DC conversion to achieve efficiency over a wide range of output voltages and/or currents of the predetermined component. The second regulator may be at least one of: a transistor, a current regulator, an operational amplifier (“op amp”), a field-effect transistor, a junction gate field-effect transistor (“JFET”), a current source, a current source with thermal compensation, a voltage regulator current source, and the MAX15041. The first regulator, the second regulator and the pot may be connected to, and in communication with, the predetermined component. The pot may include a three-terminal resistor with a sliding contact that operates as a voltage divider to be used to set the predetermined power value for the predetermined component, and may operate to set or modify the predetermined, chosen or preset value of electrical power.

The one or more power control circuits and/or systems may further include at least one of: (i) one or more analog-to-digital converters operating to convert at least one of the at least two signals, the multiplication product and the information from analog and digital; and one or more digital-to-analog converters operating to convert at least one of the at least two signals, the multiplication product and the information from digital to analog; (ii) one or more analog-to-digital converters and one or more digital-to-analog converters when one or more of the computers are in use, such that the one or more of the computers operate to sense current and/or voltage of the predetermined component with the one or more analog-to-digital converters and to provide at least one of command voltage and current to the switching regulator with the one or more digital-to-analog converters; and (iii) at least one of: a printed circuit board (“PCB”) or a prototype board; one or more capacitors; at least one inductor; at least one resistor; one or more additional voltage regulators; one or more additional current regulators; at least one snubbing network; one or more pads for use with the at least one snubbing network, the at least one resistor and the one or more capacitors; at least one of a 78L05 voltage regulator and regulator or transistor using a T0-92 structure; and a loop compensation network. The one or more capacitors may include at least six capacitors. The at least one inductor may include at least one of a 47 uH inductor, a 100 uH inductor, a 39 uH inductor, a Digi-Key 587-1700-1-ND, an inductor having an inductance in the range of about 39 uH to about 100 uH. The at least one resistor may include at least one of a 0.091 Ohm resistor and a Digi-Key RL16R.091FCT-ND.

Additionally, the one or more power control circuits and/or systems may further include a predetermined path for the at least one of consumed and delivered electrical power to travel through the power control circuits and/or systems, a first ground connection running under the PCB or the prototype board and a second ground connection running next to the power path, wherein the power path is straight and direct or substantially straight and substantially direct over the structure of the PCB or the prototype board, the first and second ground connections are disposed at the extended paddle (“EP”) under the at least one of the at least one second circuit and the at least one second processor and the EP operates to conduct heat. Additionally or alternatively, the one or more power control circuits and/or systems may further include at least one of at least one power regulator and one or more power sensors, the one or more power sensors operating to confirm that the electrical power being at least one of delivered to and consumed by the predetermined component is remaining constant or substantially constant.

It is a further object of the invention to provide a constant power IR source driver for supplying constant, stable power or substantially constant, stable power to an optical assembly, such as a Spectrometer, or one or more components thereof. The constant power circuit and/or system may be used in at least one optical instrument, such as a Fourier Spectrometer, to create an optical spectrum from a light/radiation beam and/or electrical signal created from the beam. Indeed, it is a further object of the present invention to provide an improved performance Fourier Spectrometer and/or an improved broadband light source (i.e., a light source that radiates on a broadband wavelength; also referred to as light source/beam, radiation source, radiation beam, radiation/light source, and radiation/light beam) incorporating a broadband thermal source, employing the power circuit described. In one or more embodiments, the Fourier Spectrometer may include: a Fourier modulator including a Michelson interferometer; a broadband and/or thermal light source collimated by a first optical system and incident on the Michelson interferometer therein; a second optical system collecting light transmitted by the Michelson interferometer and transmitting it to a sample region; a third optical system collecting light from the sample region and focusing it into a detector region; an optical detector located in the detector region converting the transmitted light from the sample region into an electrical signal; a power control circuit and/or system of the present invention operating to stabilize the broadband and/or thermal light source by delivering or providing a constant or substantially constant power to the broadband and/or thermal light source; and a Fourier analyzer comprising one or more electronics and software that operate to convert the electrical signal into an optical spectrum.

It is a further purpose of this invention to provide a non-transitory computer-readable storage medium containing software code operating to cause one or more of a plurality of processors to perform any of the methods of the present invention.

Other objects of the invention will in part be understandable and will in part be apparent from the following description.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown. To assist those of ordinary skill in the relevant art in making and using the subject matter hereof, reference is made to the appended drawings and figures, wherein:

FIG. 1 is a diagram showing how radiation is reflected in a prior art Michelson interferometer;

FIG. 2 is a perspective view of an interferometer having a monolithic optical assembly;

FIG. 3 is a perspective view of a monolithic optical assembly;

FIG. 4 is an overhead view of a monolithic optical assembly;

FIG. 5 is a flow chart of at least one embodiment of a method of regulating power of an electrical component and/or a power source in accordance with one or more aspects of the present invention;

FIGS. 6A-6C are diagrams of power control circuits in accordance with one or more aspects of the present invention;

FIG. 7 is a perspective view of a power control circuit and/or system in accordance with one or more aspects of the present invention;

FIG. 8 is a chart showing the resistance vs. time of a silicon carbide light source that the power circuit energizes in accordance with one or more aspects of the present invention;

FIG. 9A is a chart showing a typical variation of resistance of a silicon carbide light source in accordance with one or more aspects of the present invention;

FIG. 9B is a chart showing the output voltage of at least one embodiment of the power circuit and/or power system acting in response to the rising resistance shown in FIG. 9A in accordance with one or more aspects of the present invention;

FIG. 9C is a chart showing the corresponding (i.e., corresponding to the related data shown in FIGS. 9A-9B) current through the silicon carbide light source in accordance with one or more aspects of the present invention;

FIG. 9D. is a chart showing the corresponding (i.e., corresponding to the related data shown in FIGS. 9A-9C) power consumed vs. time of the silicon carbide light source that at least one embodiment of a power circuit and/or a power system energizes in accordance with one or more aspects of the present invention;

FIG. 10 is a schematic diagram of at least one embodiment of a power circuit and/or a power system being connected to at least one computer for use therewith in accordance with one or more aspects of the present invention;

FIG. 11 is a schematic diagram of at least another embodiment of a power control circuit where the power control circuit is digital or substantially digital in nature in accordance with one or more aspects of the present invention;

FIG. 12 is a schematic diagram of a Fourier Transform Spectrometer (FTIR) using at least one power circuit and/or at least one power system for maintaining a constant and/or a substantially constant power to the Infrared source of the Spectrometer in accordance with one or more aspects of the present invention; and

FIG. 13 is a perspective view of a Fourier Transform Spectrometer (FTIR) using at least one power circuit and/or at least one power system for maintaining a constant and/or a substantially constant power to the Infrared source of the Spectrometer in accordance with one or more aspects of the present invention.

### DETAILED DESCRIPTION OF THE PRESENT INVENTION

A power control circuit or apparatus, a power control system, a Fourier Spectrometer for use with the power control circuit or apparatus, power control system and method(s) of using same are disclosed herein. The power control circuit or apparatus operates as a predetermined component driver or a source driver to provide a constant, stable or substantially constant or stable supply of power to a predetermined component, such as a radiation source.

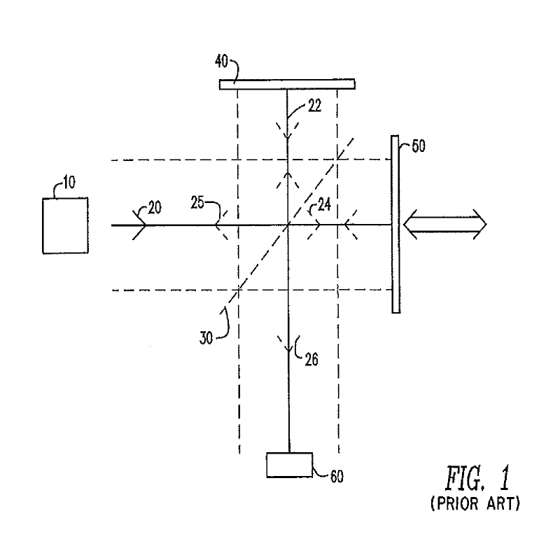

Turning now to the details of the figures, FIG. 1 shows the general principles of a standard Michelson interferometer. The Michelson interferometer has a radiation source 10 which sends a single radiation beam 20 towards beamsplitter 30 which is situated at an angle to two mirrors, a fixed mirror 40 and a movable mirror 50. Radiation beam 20 is partially reflected toward fixed mirror 40 in the form of radiation beam 22, and is partially transmitted through beamsplitter 30 towards movable mirror 50 as radiation beam 24. Beam 22 is then reflected off of fixed mirror 40, back towards beamsplitter 30, where it is once again partially split, sending some radiation 25 back towards source 10, and some radiation 26 toward detector 60. Similarly, beam 24 reflects off of movable mirror 50 and is reflected back toward beamsplitter 30. Here also, beam 24 is again split, sending some radiation back to source 10 and other radiation 26 toward detector 60.

Detector 60 measures the interference between the two radiation beams emanating from the single radiation source. These beams have, by design, traveled different distances (optical path lengths), which creates a fringe effect which is measurable by detector 60.

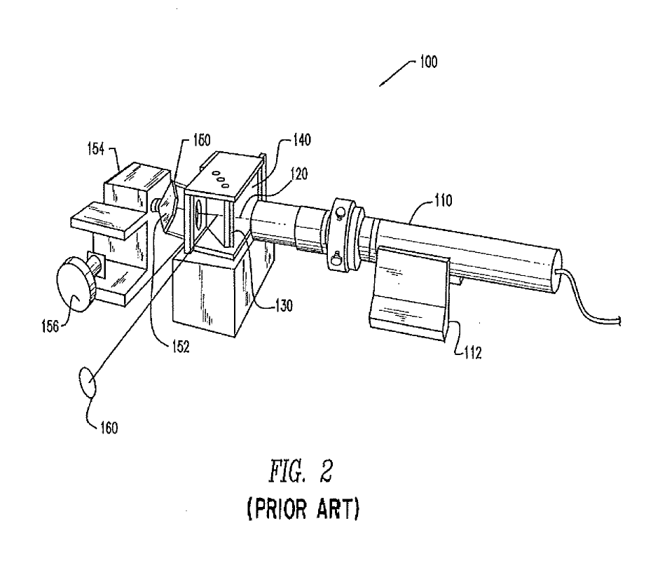

FIG. 2 shows the lay out and component structure of a Michelson interferometer of the prior art, e.g., U.S. Pat. No. 6,141,101 to Bleier, herein incorporated by reference. FIG. 2 shows interferometer 100, and includes a radiation source 110, a beamsplitter 130, a movable reflecting assembly 150, a fixed reflecting assembly 140 and a detector 142. Radiation source 110 is mounted in a secure position by mounting assembly 112. With radiation source 110 in mounting assembly 112, radiation beam 120 is alignable along a path which will fix the direction of the beam at the appropriate angle to beamsplitter 130.

Radiation source 110 can be collimated white light for general interferometry applications, such as optical surface profiling, collimated infrared light for an infrared Spectrometer, a single collimated radiation intensity laser light source, etc., for accurate distance measurements or any now known, or which become known in the future, light/radiation source used in spectroscopy. Additionally or alternatively, For operation as a Fourier Transform Spectrometer, radiation source 110 may be a broadband light source (i.e., a light source that radiates in a broad band of wavelengths; also referred to herein as (and used interchangeably with) “light”, “light source”, “radiation”, “light source/beam”, “radiation source”, “radiation beam”, “radiation/light source”, “thermal source” and “radiation/light beam”).

Movable reflecting assembly 150 may utilize a hollow corner-cube retroreflector 152. The hollow corner-cube retroreflector 152 could be made in accordance with the disclosure of U.S. Pat. No. 3,663,084 to Lipkins, herein incorporated by reference.

Retroreflector 152 is mounted to a movable base assembly 144, which assembly allows for adjustment of the location of retroreflector 152 in a line along the path of beam 120. The displacement of assembly 144 is adjustable; e.g., through use of adjusting knob 146. Other means of moving assembly 144 are also anticipated by the invention, including such means that might allow for continuous, uniform movement of assembly 144. For example, means of movement of assembly 144 might be accomplished in accordance with the structure described in U.S. Pat. No. 5,335,111 to Bleier, herein incorporated by reference, or by co-pending application Ser. No. 12/505,279 filed on Jul. 17, 2009.

The use of retroreflector 152 as the movable reflecting assembly 150 allows for any angular orientation of retroreflector 152 as long as edge portions of the retroreflector mirrors do not clip a portion of beam 120.

From the foregoing, the length of the beam paths 20, 22 and 26 are fixed and known while the length of beam path 24 may be varied. The variation of the length of beam path 26 is, of course, critical to the operation of the interferometer, as is knowing the length as precisely as possible.

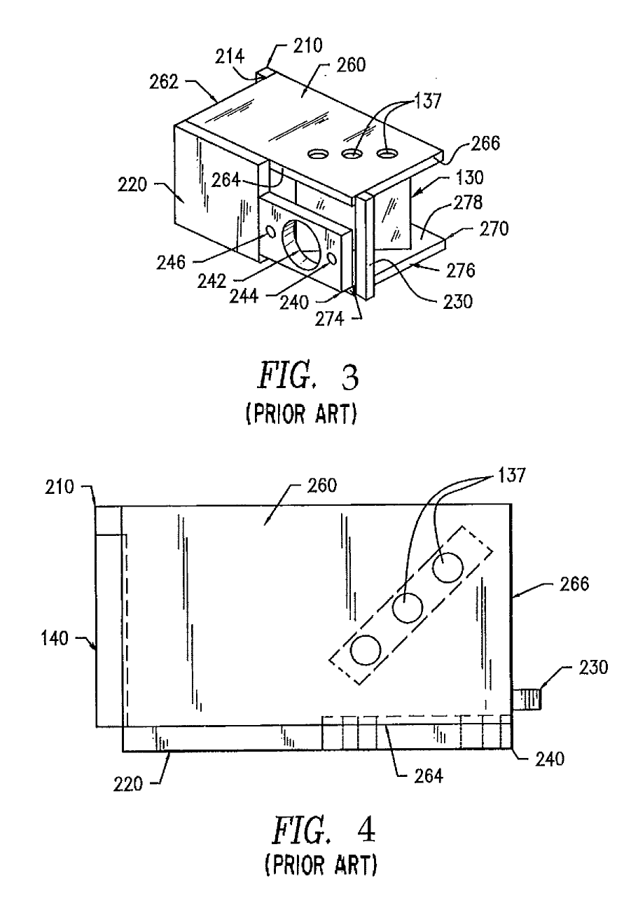

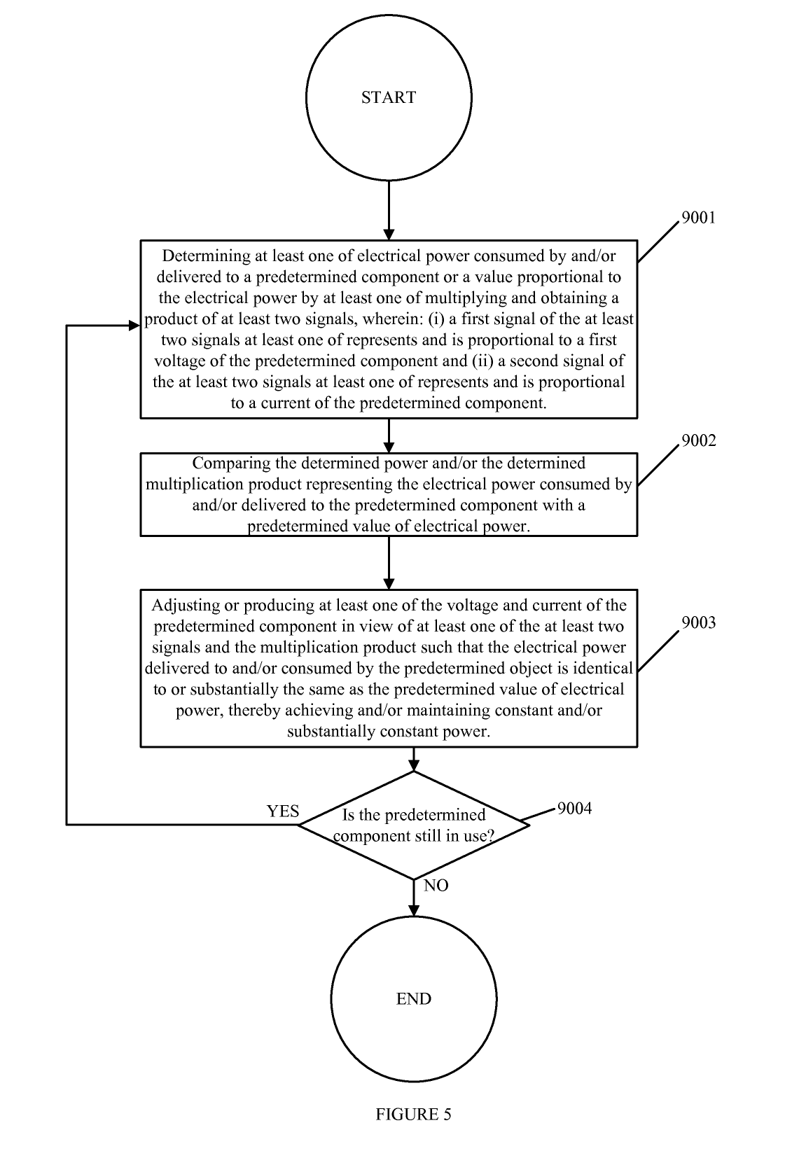

A monolithic optical assembly 200, as seen in FIGS. 3-4, comprises a beamsplitter 130 and reflecting assembly 140 mounted within a top plate 260, a bottom plate 270 and at least first and second support members 210 and 220, respectively. As an add-on for some additional structural stability, which stability is not essential, third support member 230 can also be used. Support member 210 has an edge 214. A portion of edge 214 is bonded to a portion of edge 262 of top plate 260, while another portion of edge 214 of support member 210 is bonded to a portion of an edge surface of bottom plate 270.

As shown in FIG. 4, around the corner from support member 210, is second support member 220. Second support member 220 is bonded to top and bottom plates 260 and 270 along different portions of a surface 222 thereof. The portions of surface 222 of support member 220 are bonded to portions of an edge surface 264 of top plate 260 and edge surface 274 of bottom plate 270.

Beamsplitter 130 may be comprised of two panels bonded to each other along a common surface. The common surface is an optically flat reflecting surface having a beamsplitter coating thereon. Beamsplitter 130 is bonded along portions of top edges 137 to portions of bottom surface 267 of top plate 260, and along portions of bottom edges 138 to portions of top surface 278 of bottom plate 270. One panel of beamsplitter 130 is a compensating member. The purpose of the compensating panel is to equate the material portions of the optical path difference of the two beams created by the beamsplitter. Without the compensating panel, the beam transmitted through the beamsplitter would travel through the optical material of the beamsplitter twice, while the reflected beam would travel through optical material zero times. By adding a compensating panel, ideally of the same thickness, wedge, and material as the beamsplitter, both beams travel twice through equal portions of optical material before being recombined at the beamsplitter surface, thereby equating any differences they may have experienced in that portion of their optical path length through material. The invention also anticipates a structure where the compensating panel is separated from the beamsplitter.

The support combination of first support member 210, second support member 220 and beamsplitter 130 between top plate 260 and bottom plate 270 creates a monolithic structure. As earlier discussed, it is also possible to have third support member 230 situated between portions of third edge surfaces 266 and 276 of top and bottom plates 260 and 270, respectively, as seen in the figures.

To complete the required reflecting elements of a Michelson interferometer, it is seen in the figures that a mirror panel 140 is bonded to a portion of top surface 278 of bottom plate 270, and to a second edge surface 214 of support member 210. Mirror panel 140 is slightly over hanging top surface 278 of bottom plate 270 by a portion of a bottom edge surface of mirror panel 140, and is bonded between these touching surfaces. Bonding also takes effect between the side edge surface of mirror panel 140 that touches edge surface 214 of support member 210. Bonding must avoid distorting the optically flat nature of the reflecting surface 142 of mirror panel 140.

Since mirror panel 140 is fixedly attached to assembly 200, as has just been discussed, there is no necessity for panel 140 to be other than a single, flat paneled mirror; for example, panel 140 does not need to be a retroreflector. One of the benefits of using a retroreflector (as has been discussed earlier regarding movable reflecting assembly 150 and as discussed further below) in a structure is that the orientation of the retroreflector is unimportant. The secured mounting of panel 140 to the monolithic structure assures that the orientation of panel 140 will not fluctuate due to vibration and shock, and therefore, a retroreflector is unnecessary (although a retroreflector alternatively could of course be utilized).

The portion of beam 120 that passes through beam splitter 130 and interacts with retroreflector 152 may also be returned via a second mirror panel, similar to mirror panel 140. This second mirror panel may be made integral with second support member 220 or be a separate panel supported by one or all of the second support member 220, edge 264 of top plate 260 and bottom plate 270.

Assembly 200 can also have a fourth support member 240. While the main purpose of fourth support member 240 is not to help stabilize the monolithic structure of assembly 200, it is nevertheless called a support member herein. Instead, fourth support member 240 is positioned in relation to the path traveled by beam 120 so as to allow beam 120 to pass through opening 242 in member 240, to travel between beamsplitter 130 and movable reflecting assembly 150. One or both of elements 244, 246 can comprise reflecting elements for returning beam 120 to retroreflector 252.

All members 210, 220, 230, 240, 260, 270, 130 and 140, of assembly 200, may be made of the same material. The material preferably being fused quartz or annealed Pyrex (e.g., any type of annealed borosilicate glass and/or glasses having a low coefficient of thermal expansion). The use of identical materials allows the coefficients of expansion of the materials to be identical, so that any temperature changes experienced by assembly 200 is experienced equally throughout each member to allow assembly 200 to expand and contract uniformly, thereby substantially removing distortions in the reflecting surfaces of beamsplitter 130 and mirror panel 140.

The monolithic construction discussed above has the benefit of high thermal stability in its optical alignment. This stability derives from the construction of the unit from a single, low expansion material such as Pyrex glass (e.g., any type of annealed borosilicate glass and/or glasses having a low coefficient of thermal expansion), fused silica, Zerodur or Cervit. However, in the application of infrared Fourier transform spectroscopy, often called FTIR, it may not be possible to fabricate the beamsplitter and compensating plate or panel 130 from the same material as the assembly. This may occur when the need for high transmission in the infrared (“IR”) is not consistent with available low expansion structural materials. In particular, the high IR transmission optical material may have a much higher thermal expansion coefficient.

Attaching optical elements having a thermal expansion coefficient different from the expansion coefficient of the remainder of the assembly could introduce wavefront distortion in the interfering optical beams or even result in mechanical failure under temperature changes. In order to take advantage of the permanent optical alignment afforded by a monolithic assembly, the connection between optical elements, e.g., beamsplitter and compensating plate or panel 130, and the rest of the monolithic assembly should transmit minimal stress from this assembly to the optical elements under temperature changes.

Not only are the circuits, apparatuses, systems and methods described herein unique, but the various aspects of the present invention are also nonobvious. The aforementioned, deficient methods are not capable of operating over the broad, required voltage range needed to provide constant power to a component, such as an IR source, having a resistance that is changing (e.g., increasing, decreasing, oscillating, etc.) over time. Indeed, the conventional wisdom in the art has been a lack of concern over (i.e., has been not to address) the delivery of responsive amperage when addressing the power loss problem. However, the present invention operates to provide responsive (e.g., dynamic or changing) amperage, and is not limited by the delivery of such amperage. For example, when load resistance is low, one or more embodiments of the circuit, apparatus, system, etc. of the present invention operate to deliver power levels needed for achieving constant or substantially constant power operation. Such delivery may occur at lower voltages than the input power source but at higher amperage than the input power source would be capable of. As the load resistance (e.g., the resistance of the component, such as the IR source) rises with age (as further explained above and below), the circuit delivers the same or substantially the same power to the load resistance, by controlling a combination of dynamic or changing voltage and dynamic or changing amperage. In at least one embodiment, the circuit, system, apparatus, etc. may be limited only by the input power source voltage. In other words, the one or more circuits, apparatuses, systems and methods of the present invention dynamically deliver varying voltages and currents, and may do so in accordance with the following equations:

V=sqrt(P*R) I=sqrt(P/R),

where P is the chosen constant or substantially constant power and R is the varying load resistance (e.g., the varying or changing resistance of the component, such as the IR source). Preferably, the power consumed by and/or delivered to the predetermined component is at least one of: (i) identical or substantially similar to the predetermined, preselected or chosen value of power; and (ii) constant or substantially constant. In one or more embodiments, the predetermined, electrical component (e.g., the radiation source 110) may have a resistance that changes over time, thereby requiring the dynamic control or change of at least one of the voltage and the current of the predetermined component (e.g., the radiation source 110) for providing or delivering constant or substantially constant power. The voltage may operate to be dynamic or changing in response to a changing resistance of the predetermined electrical component (e.g., the radiation source 110), and the current may operate to be dynamic or changing in response to a changing resistance of the predetermined electrical component (e.g., the radiation source 110), and both the voltage and current may operate to be dynamic or changing at once (i.e., both varying contemporaneously) in a dynamic or changing manner in response to a changing resistance of the predetermined electrical component (e.g., the radiation source 110). The step of controlling or changing the varying voltages and currents may further include at least one of: (i) changing only the voltage while keeping the current constant in response to a changing resistance of the predetermined, electrical component; (ii) changing only the current while keeping the voltage constant in response to a changing resistance of the predetermined, electrical component; and (iii) changing a combination of the voltage and the current in response to a changing resistance of the predetermined, electrical component.

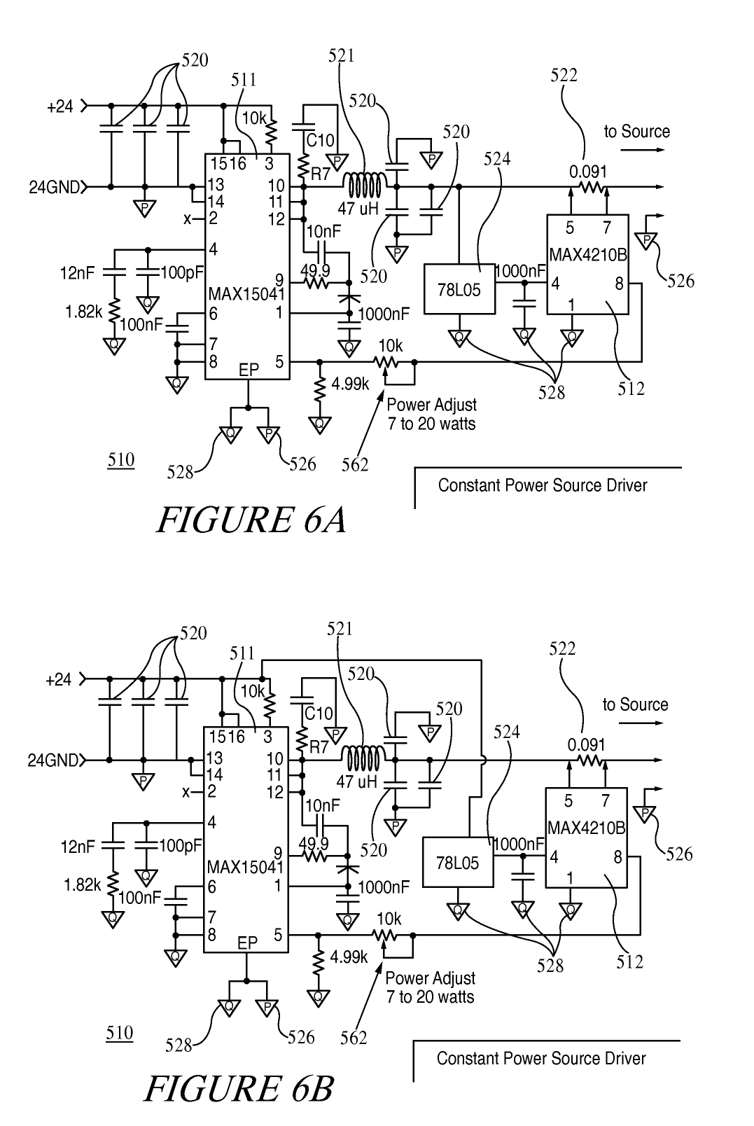

In accordance with at least one aspect of the present invention, a method for driving a power source in a stabilized and electrically efficient manner is provided (as shown in FIG. 5). The method may include: (i) determining at least one of electrical power consumed by and/or delivered to a predetermined component, such as the radiation source 110, or a value proportional to the electrical power by at least one of multiplying and obtaining a product of at least two signals, wherein: a first signal of the at least two signals at least one of represents and is proportional to a first voltage of the predetermined component, such as the radiation source 110, and a second signal of the at least two signals at least one of represents and is proportional to a current of the predetermined component, such as the radiation source 110 (see Step 9001 of FIG. 5); (ii) comparing the determined electrical power and/or the determined multiplication product representing the electrical power consumed by and/or delivered to the predetermined component (e.g., the radiation source 110) with a predetermined value of electrical power (e.g., a preset value of electrical power that the predetermined component needs to operate; a value of electrical power that a user of the predetermined component has set for the predetermined component; a factory setting of electrical power at which the predetermined component is desired to operate; a value of electrical power to be constantly maintained or achieved for delivery to and/or use by the predetermined component; a value that may be set remotely with respect to the control circuit; a value that may be set locally with respect to the control circuit; etc.) (see Step 9002 of FIG. 5); and (iii) adjusting, maintaining or producing at least one of the voltage and current of the predetermined component (e.g., the radiation source 110) in view of at least one of the at least two signals, the multiplication product, and the power determined to be delivered to and/or consumed by the predetermined objection (e.g., the radiation source 110) such that the electrical power delivered to and/or consumed by the predetermined object (e.g., the radiation source 110) is identical to or substantially the same as the predetermined value of electrical power, thereby achieving and/or maintaining constant and/or substantially constant power (see Step 9003 of FIG. 5).

The determining step (see step 9001 of FIG. 5) may further comprise computing, calculating and/or creating at least one of: (i) the voltage of the predetermined component (e.g., the radiation source 110); (ii) a voltage that is proportional to power (electrical) consumed by and/or delivered to the predetermined component (e.g., the radiation source 110); (iii) the current of the predetermined component (e.g., the radiation source 110); and (iv) a current that is proportional to electrical power consumed by and/or delivered to the component (e.g., the radiation source 110). The computing, calculating and/or creating step may further include, or may be replaced with the step of, computing, calculating and/or creating (or generating) a product of source voltage and current, or any available signals proportional to source voltage and current, thereby obtaining a signal proportional to the electrical power delivered to and/or consumed by the predetermined component (e.g., the radiation source 110).

Alternatively, in at least one embodiment where one or more of the steps are performed digitally, the computing, calculating and/or creating step may not employed or may be skipped. For example, the voltage, or a signal proportional to the voltage, delivered to the predetermined component may be measured and available, or stored, as a digital number. Typically, this is done by an analog-to-digital converter (also referred to as an “ADC”). Similarly, the current, or a signal proportional to the current, delivered to the predetermined component may be measured. Such a measurement step may further include a first step of creating a voltage proportional to the current, and a second step of converting that voltage to a number using an ADC. Having the two numbers, a computer or a processor (e.g., the computer or processor 1104 as further discussed below) then multiplies the two numbers together to form a number proportional to power. Based on this computed power, which is truly a measured power given the high accuracies of the mentioned ADC devices and methods, the computer or processor (e.g., the computer or processor 1104 as further discussed below) operates to alter at least one of the current, the voltage, and both the current and the voltage (or the product of voltage times current) delivered to the predetermined electrical component. The computer (e.g., the computer or processor 1104 as further discussed below) may execute such steps by creating one or more new command numbers for the one or more variables to be controlled, where the variables are at least one of the current, the voltage, and both the current and the voltage (or the product of voltage times current) delivered to the predetermined electrical component, and applying these numbers to one or more digitally responsive circuits, such as digital-to-analog converters (also referred to individually as a “DAC” or collectively as “DACs”), for the purpose of controlling these physical output variables. In one or more embodiments, the output voltages and/or currents of the DAC circuits may require supplementation in order to properly drive a predetermined electrical component at a constant or substantially constant power level. In such an instance, the supplementation may be provided via one or more power output stages to attain a constant or substantially constant power level. By way of example of at least one embodiment having one or more steps performed digitally, an analog output of a DAC circuit, whose value has been computed by a computer, may be wired directly to the aforementioned MAX15041 to represent the power (rather than the analog output of the MAX4210).

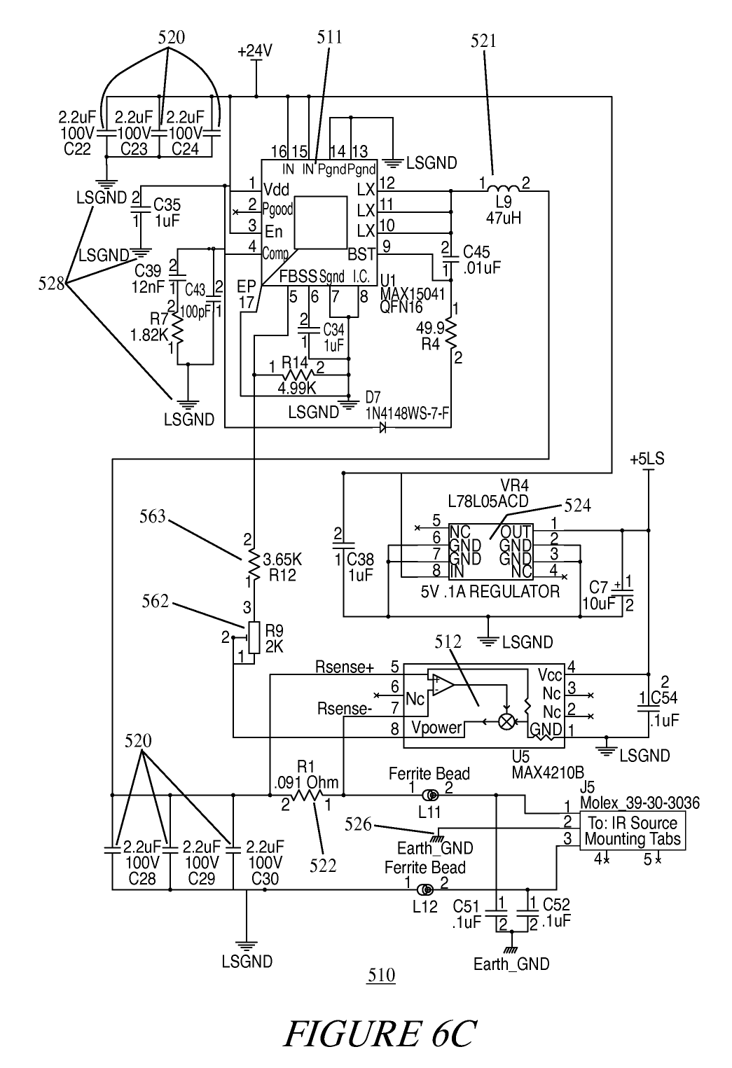

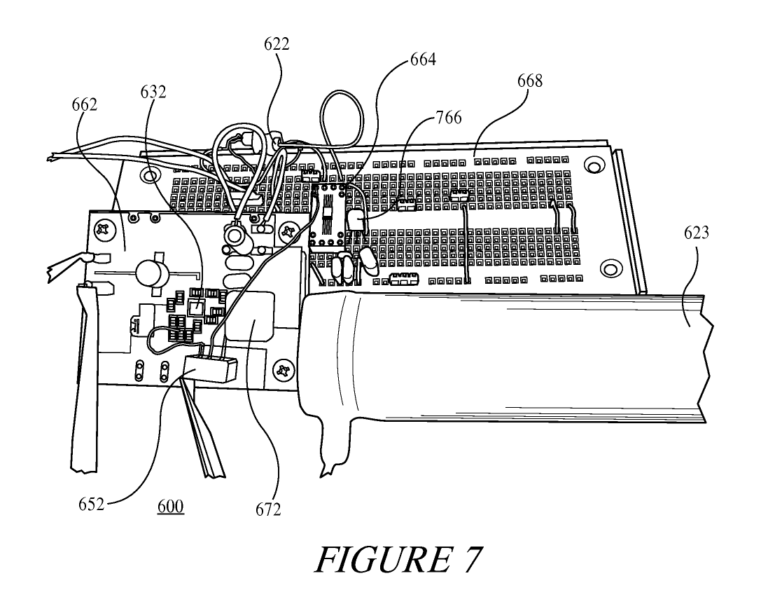

The comparing step (see Step 9002 of FIG. 5) may further comprise obtaining the predetermined value of electrical power from a processor and/or database (see e.g., processors 1103, 1104 discussed below). The predetermined value of electrical power may also be set electrically using a potentiometer (see e.g., the potentiometer (or “pot”) 562 as further discussed below and as shown in FIGS. 6A-6C; the pot 652 as further discussed below and as shown in FIG. 7; etc.). The comparing step may further comprising determining at least one of: (i) whether to increase or decrease at least one of the voltage of the predetermined component (e.g., the radiation source 110), the current of the predetermined component (e.g., the radiation source 110), the voltage that is proportional to electrical power consumed by and/or delivered to the predetermined component (e.g., the radiation source 110) and the current that is proportional to electrical power consumed by and/or delivered to the predetermined component (e.g., the radiation source 110); and (ii) how much to increase or decrease at least one of the voltage of the predetermined component (e.g., the radiation source 110), the current of the predetermined component (e.g., the radiation source 110), the voltage that is proportional to electrical power consumed by and/or delivered to the predetermined component (e.g., the radiation source 110) and the current that is proportional to electrical power consumed by and/or delivered to the predetermined component (e.g., the radiation source 110). Preferably, the increase or decrease is determined to achieve and/or maintain constant or substantially constant power delivered to and/or consumed by the predetermined component (e.g., the radiation source 110).

The adjusting step (see Step 9003 of FIG. 5) may further comprise sending at least one of the determined electrical power consumed by and/or delivered to the predetermined component (e.g., the radiation source 110), the signals and the multiplication product to a control circuit or system (see e.g., the circuit 510 and the system 600 as further discussed below and as shown in FIGS. 6A-7). In at least one embodiment, a driver electronic power control circuit (such as the circuit 510 discussed further below and as shown in FIG. 6A; another circuit 510 discussed further below and as shown in FIG. 6B; and yet another circuit 510 discussed further below and as shown in FIG. 6C) may stabilize power delivered to the component, such as the radiation source 110, by computing consumed and/or delivered power. Preferably, as aforementioned, the power is computed by multiplying, or obtaining a product of, signals proportional to the source voltage (i.e., a voltage output by the predetermined component, such as the radiation source 110) and the current (i.e., the current of the predetermined component, such as the radiation source 110) (see Step 9001 in FIG. 5). The signals, the determined delivered and/or consumed power and/or the multiplication product may be sent (e.g., as “Feedback” or “information”) to the closed-loop control circuit and/or system (e.g., the circuit 510 and/or the system 600 as discussed further below), such as, but not limited to, a switching regulator (e.g., the first integrated circuit 511, the MAX15041 or other similar circuit as further discussed below) to produce the requisite or a predetermined amount of voltage to operate the source at substantially constant and/or constant power. Additionally or alternatively, the power may be computed, calculated or created by multiplying, or obtaining a product of, the voltage of the predetermined component and the current of the predetermined component (see Step 9001 in FIG. 5). While the driver electronic circuit (e.g., the electrical circuits 510 and/or the system 600 discussed further below) is preferably utilized for a broadband thermal infrared source, one or more embodiments of the circuit may be utilized for other sources.

Additionally or alternatively, the aforementioned signals that are proportional to at least one of the voltage, the current and the power may be generated by a logarithmic amplifier and a antilogarithmic amplifier. A first logarithmic amplifier may be used to generate a voltage proportional to log (the voltage of the predetermined component, such as the radiation source 110), and a second logarithmic amplifier may be used to generate a voltage proportional to log (a current passing through the predetermined component, such as the radiation source 110). A summing amplifier may then be used to sum these two voltages, thereby creating a voltage proportional to the log of the current×voltage (i.e., the product of current and voltage). Finally, the antilog amplifier may be used to create a voltage proportional to power.

Preferably, the control circuits 510 (three embodiments of which are shown in FIGS. 6A-6C) and/or the control system 600 (best seen in FIG. 7), or a portion thereof, operates in a closed-loop fashion to maintain a constant or substantially constant power delivered to the predetermined component, such as the radiation source 110. As shown by Step 9004 in FIG. 5, if the predetermined component is still in use, the determining, comparing and adjusting steps may be repeated or recycled as needed to achieve and/or maintain a constant or substantially constant electrical power delivered to and/or consumed by the predetermined component. If the predetermined component is not in use, the method may end. Additionally or alternatively, if at least one of the circuit and system (e.g., one or more of the circuits 510 and/or the system 600) is operational, the steps may recycle or repeat automatically until the control circuit and/or system and/or the predetermined component is turned off.

Preferably, a first circuit and/or integrated circuit 511 (best seen in FIGS. 6A-6C), such as, but not limited to, the MAX15041 or other similar circuit as further discussed below, is used to compare the sample of the output voltage with the reference voltage. As aforementioned, the first circuit 511 may operate as a switching regulator that may be used to regulate voltage and/or current of the predetermined component. Preferably, a second circuit and/or integrated circuit 512 (best seen in FIGS. 6A-6C), such as, but not limited to, the MAX 4210B or any similar model (e.g., the MAX 4210/MAX 4211), is used to create, determine, calculate and/or compute a voltage and/or a current that is proportional to power consumed and/or delivered to the predetermined component (e.g., the radiation source 110), and/or is used to create, determine, calculate and/or compute a product or digital value proportional to the product of the voltage and the current of the predetermined component, thereby obtaining power delivered to and/or consumed by the predetermined component. The signals, the determined consumed and/or delivered power and/or the multiplication product (collectively referred to as “the Feedback” or “the information”) may be sent to the first circuit or integrated circuit, such as, but not limited to, the circuit 511, the MAX15041 or other similar circuit, a regulator, etc. in one of a plurality of ways known to those skilled in the art, including, but not limited to, a direct connection, a wireless connection, the use of a digital-to-analog converter (“DAC”), etc. The first integrated circuit may then use the signals, the consumed power, and/or the multiplication product to produce the modified voltage and/or current to operate the predetermined component, such as the radiation source 110, at a constant or substantially constant power. Those skilled in the art would appreciate that the first circuit or integrated circuit (e.g., the integrated circuit 511) may be at least one of an integrated circuit, a MAX15041, a switching regulator, and a closed-loop switching regulator, and that the second circuit or integrated circuit (e.g., the integrated circuit 512) may be at least one of an integrated circuit, a MAX 4210B, a MAX 4210, and a MAX 4211. The signals and/or the multiplication product may be substantially digital in nature, with analog signals being converted into digital signals via analog-to-digital converters (“ADCs”), and the digital signals may be converted to analog signals via digital-to-analog converters (“DACs”).

The first circuit or integrated circuit (e.g., the integrated circuit 511) may include at least one switching regulator and/or at least one closed-loop switching regulator to produce at least one of the varied or changed voltage and the varied or changed current to operate the predetermined component at constant or substantially constant power. The switching regulator and/or the at least one closed-loop switching regulator (see e.g., element 511 of FIGS. 6A, 6B and/or 6C) may further include a first regulator and a second regulator, the first regulator operating to produce at least one of the varied or changed voltage to operate the predetermined component at constant or substantially constant power and the second regulator operating to produce the varied or changed current to operate the predetermined component at constant or substantially constant power. The first regulator may be any voltage regulator known to those skilled in the art, including, but not limited to at least one of: a voltage regulator, a voltage switching regulator, a voltage regulator with an operational amplifier (“op amp”), a transistor regulator, silicon controlled rectifiers (“SCR”), a voltage stabilizer, and the MAX15041 (see e.g., element 511 of FIG. 6). The second regulator may be any current regulator known to those skilled in the art, including, but not limited to, a transistor, a current regulator, an operational amplifier (“op amp”), a field-effect transistor, a junction gate field-effect transistor (“JFET”), one or more current regulator diodes, a current source, a current source with thermal compensation, a voltage regulator current source, and the MAX15041 (see e.g., element 511 of FIG. 6).

In accordance with at least one aspect of the present invention, FIGS. 6A-6C show diagrams of three embodiments of an electrical circuit 510 for maintaining or providing a constant or substantially constant power for a component, such as the radiation 110 source, for reducing and/or minimizing power decay within the component, such as the radiation 110 source, and for providing an improved electrical component driver, infrared source driver or a power source in general. As aforementioned, the first integrated circuit 511 is a switching regulator that would normally be used to regulate voltage and/or current of the predetermined component. The MAX15041 or any other similar circuit as discussed herein may be used as the switching regulator and uses synchronous DC-DC conversion to achieve good efficiency over a wide range of output voltages and/or currents of the predetermined component. The second integrated circuit 512 operates to create a voltage and/or a current which is proportional to power consumed. The MAX 4210B may be used for the second integrated circuit. The schematics of FIGS. 6A-6C show how the two integrated circuits 511, 512 may be connected together in accordance with the invention. If the MAX15041 is connected conventionally, the power adjustment potentiometer (or “pot”) 562 is preferably connected to the predetermined component, such as the radiation source 110. The pot 562 may be, but is not limited to, a three-terminal resistor with a sliding contact that operates as a voltage divider. As aforementioned, the pot 562 may be used to set the predetermined power value for the predetermined component. The MAX4210B operates to sense a voltage drop across the 0.091 Ohm resistor and multiplies that value by the voltage appearing on pin 5 thereof. Additionally or alternatively, the power may be adjusted remotely. The product, which is in the form of a voltage, appears on pin 8, which is where the pot is connected.

In at least one embodiment, one or more components of the combined integrated circuit (e.g., the control circuit 510) may be employed as follows: The six (6) capacitors (see elements 520 in FIGS. 6A-6C) may be 2.2 uf/100 volts ceramics, which is a part already used on the power supply printed circuit board (or “PCB”) or on the prototype board (see e.g., element 668 in FIG. 7) and having a Digi Key number of 445-4497-1-ND. The 47 uH inductor (see element 521 in FIGS. 6A-6C) may be a Digi-Key 587-1700-1-ND. Alternatively, a 100 uH inductor may be used (as is used as the inductor 672 in the system 600 best seen in FIG. 7). While one or more calculations preferably call for a 39 uH inductor, if that type of inductor is not available, the closest type of inductor may be employed, such as the 47 uH inductor (element 521 shown in FIGS. 6A-6C). The 0.091 Ohm resistor (element 522 in FIGS. 6A-6C) may be a Digi-Key RL16R.091FCT-ND. The arrow pointers from pins 5 and 7 of the MAX4210B (and directed towards the 0.091 Ohm resistor (element 522 in FIGS. 6A-6C)) each indicate a respective “Kelvin Connection”, which is a four wire-contact method for measuring resistance that eliminates the errors from lead resistance and clip resistance. The 78L05 (element 524 in FIGS. 6A-6C) regulates 5 volts for the MAX4210B. The MAX15041 has a 5 volt regulator, but, in one or more embodiments, the 5 volt regular of the MAX15041 may not be useable externally and must be bypassed (See pin 1 thereof as shown in at least FIGS. 6A and 6B).

While in at least one embodiment (see the system 600 in FIG. 7) the snubbing network, R7 and C10 are not used, in one or more embodiments such components are used. As such, in one or more embodiments, one or more pads should be employed in the event the snubbing network, R7 and/or C10 are used.

While the loop compensation network on pin 4 of the MAX15041 may change from one embodiment of the circuit to the next, the network on pin 4 as shown in FIGS. 6A-6C may be employed in at least one embodiment.

Preferably, the power path is as straight and direct as possible over the topography or structure of a printed circuit board (“PCB”) (or of a socketed prototyping board, which may be alternatively used for a PCB in one or more embodiments, such as, but not limited to, the prototyping board 668 in FIG. 7). In the prototyping board used in the embodiment shown in FIG. 7, the “P” ground (see e.g., element(s) 526 in FIGS. 6A-6C) runs next to the power path. In at least one embodiment, such as in the layout for the system 600 shown on the prototyping board 668 in FIG. 7, the “Q” ground (see e.g., elements 528 in FIGS. 6A-6C) runs under everything else. Such a layout may be critical in one or more embodiments. The “P” and “Q” grounds preferably get connected in one place only, i.e., at location “EP” (stands for extended paddle) under the MAX15041 (best seen in FIGS. 6A and 6B). Preferably, the extended paddle or “EP” operates to conduct heat. Alternatively, other means for conducting heat known to those skilled in the art may be employed.

In one or more embodiments, the 78L05 (element 524 in FIGS. 6A-6C) may be connected to the circuit in one or more different ways. For example, as shown in FIG. 6A, the 78L05 (element 524 in FIG. 6A) is connected directly to the connection extending between the 47 uH inductor (element 521), the capacitors (elements 520) and the resistor (element 522). Alternatively and preferably, as shown in FIG. 6B (which depicts the same diagram as shown in FIG. 6A with the following exception), the 78L05 (element 524 in FIG. 6B) is instead connected to the connection extending between the capacitors (elements 520 shown on the top left portion of FIG. 6B) and the 10K resistor connected to the MAX15041. Additionally or alternatively, as shown in FIG. 6C, the 78L05 (element 524 in FIG. 6C) may similarly be connected to the connection extending between the capacitors (elements 520 shown on the top left portion of FIG. 6C) and the MAX15041.

Those skilled in the art will also appreciate that further modifications may be made to the schematics shown in FIGS. 6A-6B. For example, as best seen in FIG. 6C, while the circuit 510 may still employ one or more of the same components (e.g., the first integrated circuit 511, the second integrated circuit 512, the capacitors 520, and the other elements 521, 522, 524, 526, 528, 562, etc. as aforementioned and further discussed below), the circuit 510 may include components (which may be in addition or alternative to components shown in FIGS. 6A-6B or which may be specific components used for implementing connections diagrammatically represented in FIGS. 6A-6B), such as, but not limited to, the J5 Molex being connected to the predetermined component, such as the IR source (e.g., the radiation source 110); a fixed resistor 563, etc. That said, the circuits 510 shown in FIGS. 6A-6C all operate similarly (if not identical) to maintain a constant or substantially constant power and/or provide a predetermined or preselected amount of power to the predetermined component, such as the IR source (e.g., the radiation source 110), thereby reducing, minimizing or eliminating power decay within the predetermined component.

In general, it may be desirable to limit the power level to the predetermined component, such as the IR source (e.g., the radiation source 110), to a range of values such that damage to the predetermined component is prevented while maintaining adjustment sensitivity. For example, as shown in FIG. 6C, the fixed resistor 563 acts with potentiometer 562 to limit the maximum power that may be set and delivered to the resistance load of the predetermined component, such as the IR source (e.g., the radiation source 110). For example, in FIGS. 6A and 6B, the circuits 510 may operate to deliver between about 7 watts and about 20 watts whereas the circuit 510 of FIG. 6C may be limited to deliver between about 7 watts and about 15 watts.

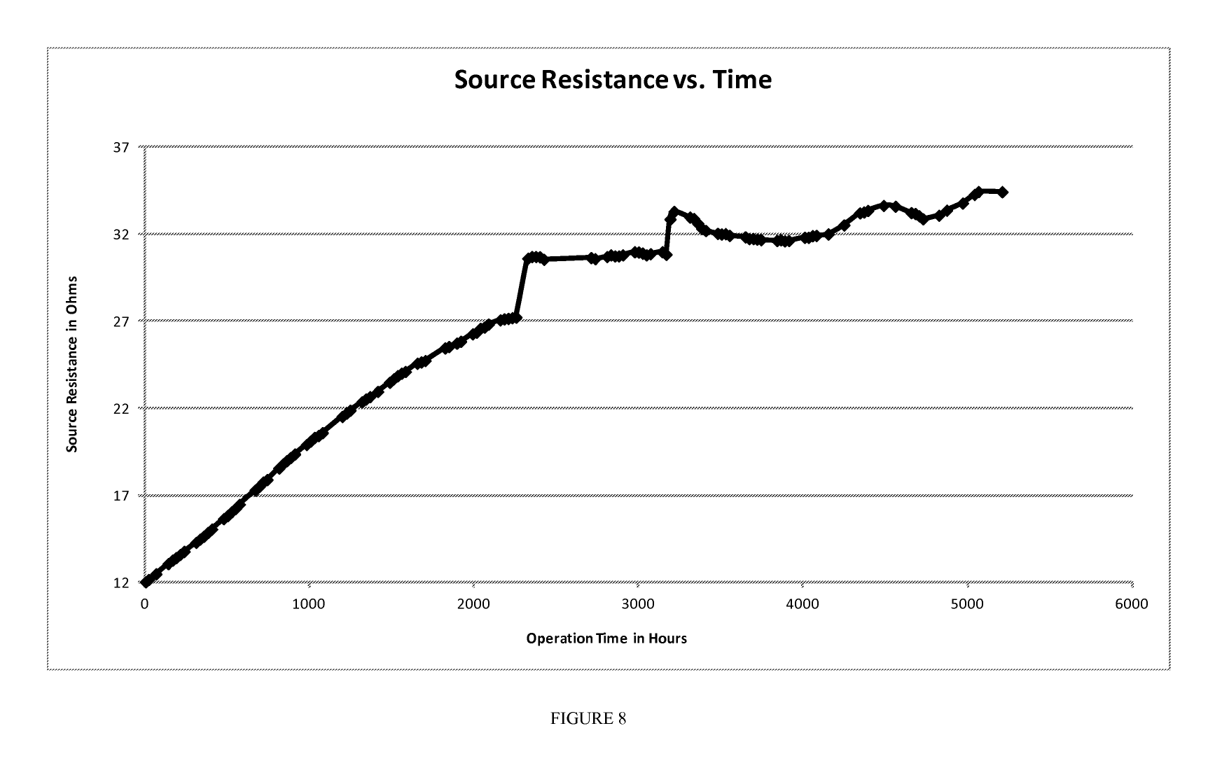

While a control circuit or system may be based on the circuits 510 shown in FIGS. 6B-6C as aforementioned, the control circuit or system 600 (best seen in FIG. 7) was based substantially on the circuit 510 shown in FIG. 6A. For example the MAX15041 (see element 662 in FIG. 7) was employed. While the system 600 of FIG. 7 also differs from the circuits 510 of FIGS. 6A and 6B in several ways, such differences may change depending on the circumstances surrounding the need(s) to be solved by the circuit, apparatus or system of the present invention. Indeed, for at least one or more embodiments, a circuit or system may be built using the exact schematic shown in FIG. 6B or the schematic shown in FIG. 6C. The system 600 drives a 14.0 Ohm resistor (element 623 as shown in FIG. 7). By way of a conducted experiment using the system 600, the pot 652 was set so that the output was 12.96 volts, 12 watts having been delivered to the resistor 623. A new source has a resistance of ˜8 Ohms. When the resistance curve was extrapolated for an old source (e.g., a source that has about 6000 hours of time on it or more), it was found that the resistance of the old source increased to about 40 Ohms. As an additional experiment conducted and as discussed above regarding FIG. 8, a similar increase in resistance was shown for a radiation source.

In accordance with an aspect of the present invention, the constant power driver, circuit, and/or system (e.g., circuit 510, system 600, etc.), and methods of using same, may operate to deliver 12 watts (or any other predetermined value of constant or substantially constant electrical power as described above) in all cases (or in certain scenarios), thereby solving the “aging source problem” discussed above. Preferably, the system 600 includes a power regulator 632. Additionally, the system 600 may use a power sensor 664 (or more than one power sensor 664) on the PCB or the prototyping board 668 to help regulate the power, and, in the very least, to confirm that the electrical power being delivered to and/or consumed by the predetermined component (e.g., the radiation source 110) is remaining constant or substantially constant.

Because the power is constant (or substantially constant) and stable in accordance with one or more aspects of the present invention, the source may warm up slowly in one or more embodiments. Preferably, the source warms up slowly. Given the new and unique circuit designs shown in at least FIGS. 6A-6C and FIG. 7, the design desirably provides an overall efficiency exceeding 90 percent. Indeed, the new circuit design of the present invention and the aforementioned methods of providing constant or substantially constant power exceed expectations.

As shown in FIG. 7, a perspective view of a system 600 of the new power circuit is shown. The red item 622 at the top left of the system 600 is the 0.091 Ohm resistor. The system 600 employs ten (10) inches of wire wrap wire, and the aforementioned Kelvin connection(s). As aforementioned, while the inductor may be (and is preferably) a smaller inductor, a 100 uH inductor (see element 672 in FIG. 7) was used for the system 600. The 78L05 component in the system 600 is the TO92 component (element no. 766 in FIG. 7).

Using the new circuit design discussed herein, all the parts thereof may be very small, and less than a watt of power may be lost in the regulator. Even for the system 600 shown in FIG. 7, no component was detectably warm except for the resistor 623 during the experiment conducted.

As shown in FIG. 8, the source resistance changed quite rapidly and linearly over the first 2000 hours. This is in approximated concordance with a (1-decaying exponential) behavior. As such, the switch mode nature of the one or more power circuits 510 is compliant with a large range of resistances. The discontinuities in the curve of FIG. 8 indicate one or more switches in the polarity across the predetermined component, such as the IR source (e.g., the radiation source 110). Previously, without the use of the one or more circuits 510 and/or the system 600, there would normally be a significant diode effect where the resistance is different in each direction. Use of one or more embodiments of the present invention avoids or resists the diode effect. Specifically, if the polarity of the predetermined component is reversed, the methods disclosed herein, the one or more circuits 510 and/or the power system 600 compensates for such diode effects.

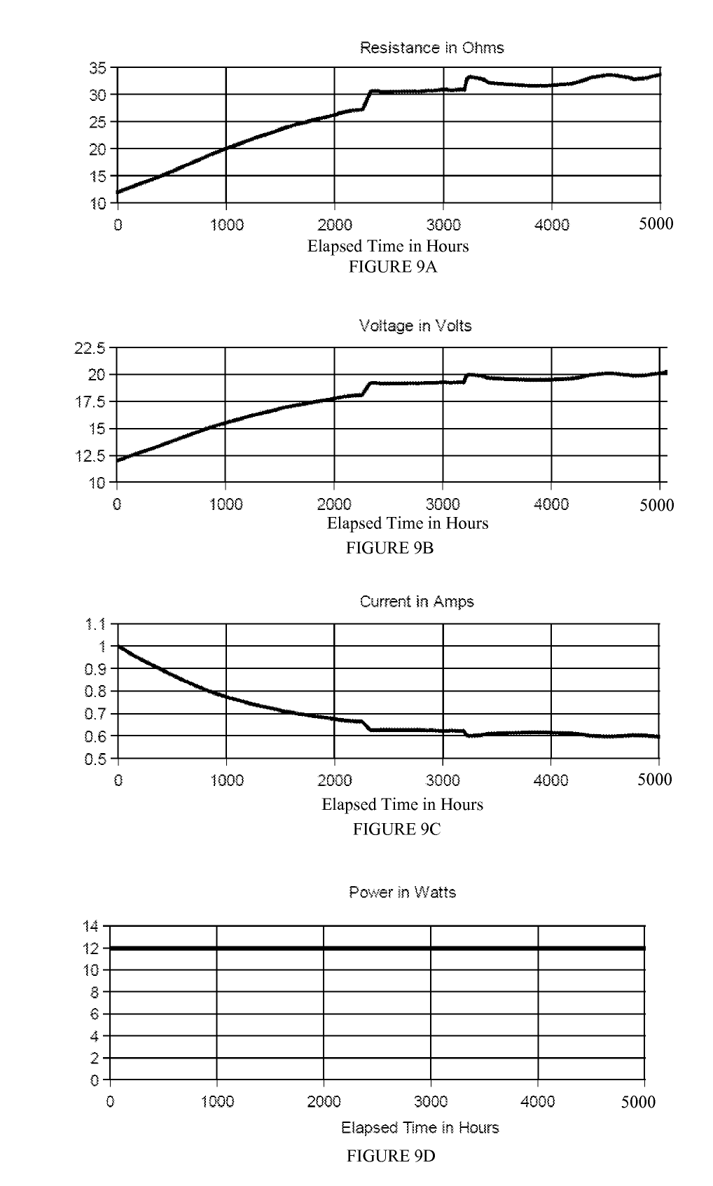

As shown in FIGS. 9A-9D, constant, consistent power was provided (best seen in FIG. 9D) to the predetermined component, e.g., a radiation source (which, in this particular instance, was a silicon carbide source even though other radiation sources may be used, such as the radiation source 110) while resistance changed over time (best seen in FIG. 9A). Even though resistance changed over time as shown in FIG. 9A, the voltage and the current of the predetermined component was controlled dynamically over the same period of time (as shown in FIGS. 9B-9C) to achieve the constant, consistent power provided (as shown in FIG. 9D).

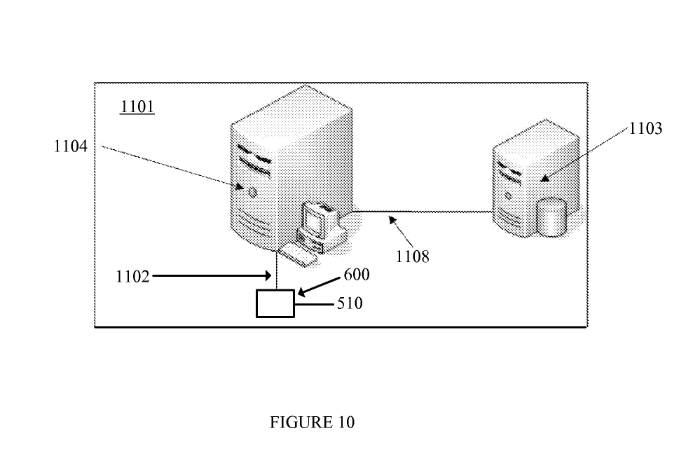

There are many ways to compute power, digital as well as analog. In at least one embodiment, a computer may be dedicated to the control and the monitoring of the power circuit, such as the one or more control circuits 510 and/or the power control system 600. As shown in the schematic view of FIG. 10, system 1101 operates to provide and/or maintain the constant, stable or substantially constant, stable power to the predetermined component, such as the radiation source 110, as discussed above in accordance with one or more aspects of the present invention. The system 1101 may include at least a first processor (also may be referred to as a “computer”) 1104, and at least a second processor (also may be referred to as a “computer”) 1103. The processors 1103, 1104 may operate as one or more databases to store information for use by the processors 1103, 1104. The processors 1103, 1104 may be used to maintain or provide constant power in accordance with one or more aspects of the present invention. The at least one second processor and/or database 1103 may be used by, or together with, the at least one first processor 1104. For example, the processors 1103, 1104 may store any predetermined values (e.g., the predetermined value of electrical power as aforementioned) for use by a power control circuit or system (e.g., the one or more control circuits 510, the control system 600, etc.). The processors 1103, 1104 may be connected to each other by way of a connection 1108 (e.g., a network connection), and the processors 1103, 1104 may be connected to the control circuit and/or the control system 600 via a connection 1102 (e.g., a network connection) (as best seen in FIG. 10). The processors 1103, 1104 may be located in the same telecom network or in different telecom networks (e.g., the predetermined component may be controlled remotely). If a computer is used in at least one embodiment of the present invention, the computer may sense source current and/or voltage with one or more analog-to-digital converters. The computer could then provide command voltage to the regulator via a digital-to-analog converter. The DACs and/or the ADCs may be included in the computer, such as the processors 1103, 1104, or may be included as a portion of the one or more power circuits 510 and/or the system 600.

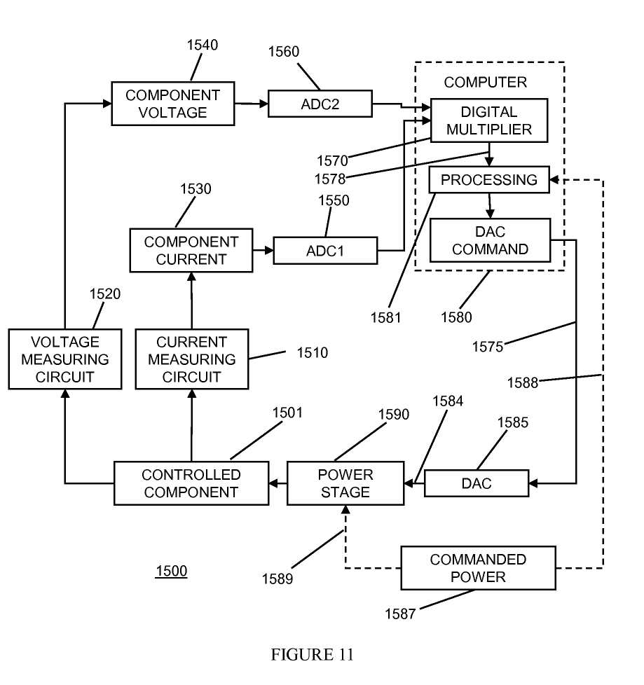

As an alternative or additional embodiment, the one or more power circuits 510 and/or the power system 600 may be digitally or substantially digitally implemented as shown in FIG. 11. A substantially digital implementation of the power control circuit and/or system 1500 may include a current measuring circuit 1510, a voltage measuring circuit 1520, one or more analog signals 1530, 1540, one or more ADCs 1550, 1560, a digital multiplier 1570 (which may be part of a processor or a computer 1580), and a power stage 1590. The current measuring circuit 1510 operates to provide an analog signal 1530 proportional to the current in the controlled or predetermined component 1501 (e.g., such as an IR source; the radiation source 110; etc.). Any current measuring circuit known to those skilled in the art may be used as the current measuring circuit 1510. The analog signal 1530 may physically be a voltage. The voltage measuring circuit 1520 operates to provide an analog signal 1540 proportional to the voltage across the controlled or predetermined component 1501 (e.g., such as an IR source; the radiation source 110; etc.). The analog signal 1540 also may physically be a voltage. A first analog-to-digital converter (ADC1) 1550 operates to create a digital, numerical representation of the current signal 1530. A second analog-to-digital converter (ADC2) 1560 creates a digital, numerical representation of the voltage signal 1540. The digital multiplier 1570 operates to receive the digital outputs of ADC1 1550 and ADC2 1560, and the digital multiplier 1570 further operates to multiply the digital outputs of ADC1 1550 and ADC2 1560 together, thereby creating a digital product 1578 accurately representative and proportional to the power dissipated in the controlled or predetermined component 1501 (e.g., such as an IR source; the radiation source 110; etc.). The digital multiplier 1570 may be part of a larger digital system 1580, which may be a computer or processor (e.g., one of the computers or processors 1103, 1104), microprocessor, microcontroller, or personal computer, or digital computer board, or may operate outside of a computer program. One or more interface circuits known to those skilled in the art, such as, but not limited to, line drivers, multiplexers and demultiplexers, deserializers, buffers, registers, etc., may be employed to convey the digital signals from the ADCs 1550 and 1560 and make them useable by the computer 1580 and the digital multiplier 1570.

The circuit and/or system 1500 may operate in a loop, and the loop may be closed in a number of ways. A suitable DAC command value 1575 may first be generated from the output of the digital multiplier 1570 using a digital product 1578 and the processing step 1581. This causes DAC 1585 to provide a feedback input 1584 to the power stage 1590, which also may receive a desired, commanded power input 1589 from a commanded power value 1587. The commanded power input 1589 may be a reference value that properly scaled feedback input 1584 must meet when the loop is closed. Additionally or alternatively, the commanded power input 1589 may be the actual desired power level to be delivered to the controlled or predetermined component 1501 (e.g., such as an IR source; the radiation source 110; etc.). Power stage 1590, which is capable of the full, requisite power level required by component 1501, then acts to provide the commanded power to component 1501.

The loop may also be closed using the computer 1580, which acts via the processing step 1581. The computer 1580 uses the output (also referred to as the digital product) 1578 of the digital multiplier 1570 and the commanded power value 1587 to compute the DAC command 1575 by the processing step 1581. The DAC command 1575 then controls the power stage 1590 via the output 1584 of the DAC 1585, thereby causing commanded power to be provided to component 1501.

It will be appreciated that the power stage 1590 may have many forms. Regardless of the form, the power stage 1590 operates to control at least one of the current, the voltage, and the product of current and voltage delivered to the predetermined component 1501 (e.g., such as an IR source; the radiation source 110; etc.), these values being derived, in the closed loop operation, from the commanded power 1587, and the digitally measured and multiplied values of the actual current and voltage employed by the predetermined component 1501 (e.g., such as an IR source; the radiation source 110; etc.). As a concrete example, a suitably scaled analog output (e.g., the output 1584) of a DAC circuit (e.g., DAC 1585), the value of the output having been computed by the computer 1580, may be wired directly to the aforementioned MAX15041, which may operate as the power stage 1590 in one or more embodiments of the circuit and/or system 1500. The digital multiplier 1570, used with inputs (i.e., input into the multiplier 1570) from the ADCs 1550 and 1560 (i.e., output from the ADCs 1550 and 1560), and suitably scaled in the processing step 1581, may form the input 1575 to the DAC 1585, which then generates the output 1584. In this way, the aforementioned second integrated circuit 512 (e.g., an analog multiplier MAX 4210 or some other similar circuit as described herein) may be replaced by the digital implementation disclosed herein.

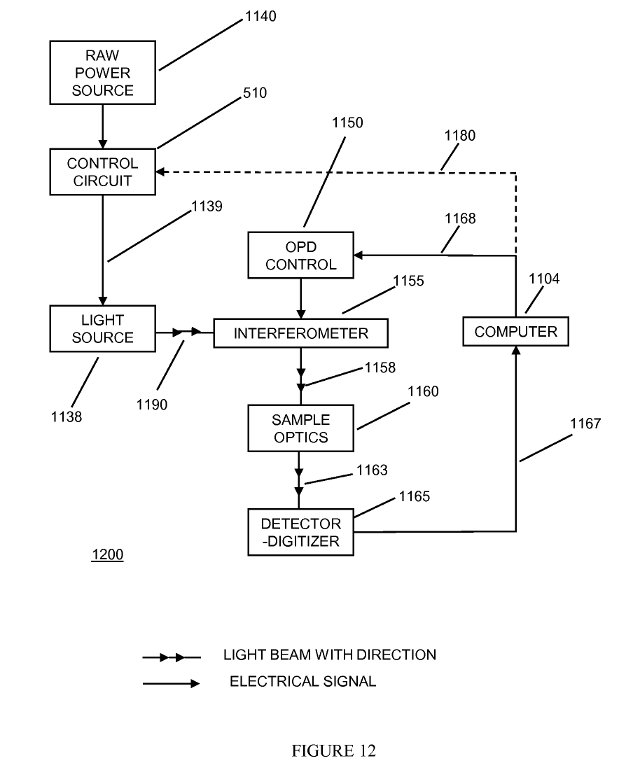

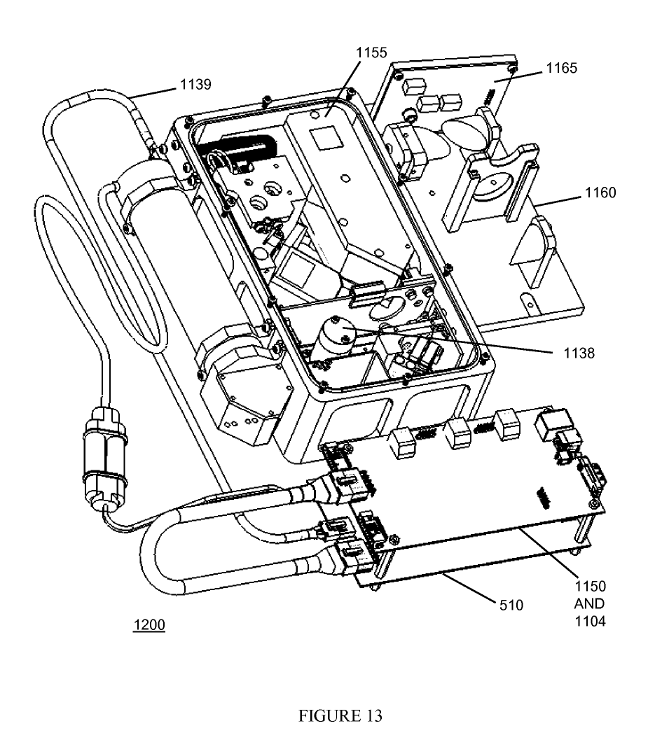

Such improvement of power delivery and minimization and/or reduction of power loss as discussed herein is important for precision instrumentation applications. Indeed, as one example of such precision instrumentation application as best seen in the diagram view shown in FIG. 12 and as best seen in the perspective view shown in FIG. 13, it is a further object of the present invention to provide a Fourier Spectrometer (“FTIR”) using the one or more power circuits 510 and/or the system 600 of the present invention to provide a constant or substantially constant and stable or substantially stable power supply to the source thereof. The one or more power circuits 510 and/or system 600 may be used in at least one optical instrument, such as a Fourier Spectrometer, to create an optical spectrum from a light/radiation beam and/or electrical signal created from the light beam (e.g., from the broadband beam source, such as the radiation source 110). In at least one embodiment, the Fourier Spectrometer may incorporate a broadband thermal source while employing the one or more power circuits 510 and/or the system 600 as discussed herein. While other components of such an improved Fourier Transform Spectrometer (FTIR) may be of any design known in the art, the improved Fourier Transform Spectrometer preferably includes at least one of the one or more source driver circuits 510 and/or the system 600 (also referred to as the “infrared (“IR”) source driver”) as discussed herein to stabilize the input light source (e.g., the thermal light source). At least one embodiment of the FTIR may include a Fourier Modulator including a Michelson interferometer, a the broadband beam source (e.g., the radiation source 110) collimated by a first optical system and incident on the Michelson interferometer (e.g., the interferometer 100) therein, a second optical system collecting light transmitted by the Michelson interferometer (e.g., the interferometer 100) and transmitting it to a sample region, a third optical system collecting light from the sample region and focusing it into a detector region, an optical detector (e.g., the detector 60, the detector 142; etc.) located in the detector region converting the transmitted light from the sample region into an electrical signal, and a Fourier analyzer comprising one or more electronics and software that operate to convert the electrical signal into an optical spectrum.

Turning to the details of FIG. 12, FIG. 12 is a schematic diagram of a Fourier Transform Spectrometer System 1200 incorporating at least one embodiment of the power control circuit 510 disclosed. A raw power source 1140, which in one embodiment may be any DC voltage between 9 and 36 volts, may operate to provide power to energize various the one or more modules shown, including the power control circuit 510, which operates to regulate the power of a light source 1138 (e.g., a thermal light source, such as, but not limited to the radiation source 110). The thermal light source 1138 is connected to the control circuit 510 by a cable 1139 (e.g., a simple two-wire cable with a shield). In some embodiments, the control system 510 may not calculate power directly but may require assistance of an external computer, such as the computer or the processor 1104 (or, alternatively, the computer or processor 1103 as shown in FIG. 10). A connection 1180 denotes a connection to the computer 1104 facilitating the computer 1104's control of the control system 510 for the purpose of stabilizing the power in the light source 1138. Additionally or alternatively, a computer, such as the computer 1104, may be at least one of part of, enclosed in and integral with the control circuit 510 for the purpose of stabilizing the power in the light source 1138. An optical beam 1190, after suitable collimation (e.g., as discussed above), is directed into an interferometer, such as an interferometer 1155 (or the interferometer 100 as discussed above). To obtain an optical spectrum, the optical path difference (“OPD”) of interferometer 1155 (or of the interferometer 100 as discussed above) must be precisely controlled by means known to those skilled in the art of Fourier Transform Spectrometer design. This control is done by an OPD control 1150, which operates under command of the computer 1104 through an electrical connection 1168. An output optical beam 1158 is passed to one or more sample optics 1160, and the output optical beam 1158 functions or operates to contain or access the sample under study, and transmit through, or reflect off the sample. The sample optics 1160 then recollects the light remaining after interaction with the sample and sends the optical beam 1163 to a detector-digitizer 1165. A digital, numerical signal is then sent over an electrical connection 1167 to the computer 1104, which analyzes the digital, numerical signal to form a spectrum, or transmits the signal to another computer (e.g., the computer 1103 as shown in FIG. 10) via a network connection (e.g., connection 1108 as seen in FIG. 10) including, but not limited to, an internet connection, a wireless connection, etc., for the purpose of computing and displaying the spectrum. The connections 1167 and 1168 are actually bidirectional, allowing the computer 1104 to adjust parameters on the detector-digitizer 1165, and possibly to trigger the detector-digitizer 1165, based on a signal reported by the OPD control 1150 over the connection 1168.

FIG. 13 is a perspective view of a practiced Fourier Transform Spectrometer System, such as the Fourier Transform Spectrometer System 1200 as diagrammatically shown in FIG. 12, in accordance with one or more aspects of the present invention. One or more items shown in FIG. 12 are evident in FIG. 13, and the functions and references of those items are as described above in reference to FIG. 12. Indeed, those skilled in the art will appreciate that the elements (e.g., the circuit 510, the computer 1104, the OPD control 1150, the light source 1138, the one or more sample optics 1160, etc.) of the system 1200 of FIG. 13 may operate in the same or similar fashion to those like-numbered elements of the system 1200 shown in FIG. 12 as discussed above or any additional like-numbered elements discussed further herein below.

Any methods of the present invention, such as the methods for using the power control circuit and/or system, may be stored on a computer-readable storage medium. A computer-readable storage medium used commonly, such as, but not limited to, a hard disk, a flash memory, a CD, a DRAM or the like, an optional combination thereof, a server/database, etc. may be used to cause a processor, such as, the processors 1103, 1104 of the aforementioned computer system 1101 to perform the steps of the methods disclosed herein. The computer-readable storage medium may be a non-transitory computer-readable medium, and/or the computer-readable medium may comprise all computer-readable media, with the sole exception being a transitory, propagating signal. The computer-readable storage medium may include media that store information for predetermined or limited or short period(s) of time and/or only in the presence of power, such as, but not limited to Random Access Memory (RAM), register memory, processor cache(s), etc.

In accordance with at least one aspect of the present invention, the methods, systems, and computer-readable storage mediums related to the processors, such as, but not limited to, the processor of the aforementioned computer, etc., as described above may be achieved utilizing suitable hardware, such as that illustrated in the figures. Functionality of the invention may be achieved utilizing suitable hardware, such as that illustrated in FIG. 10. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. The processors 1103, 1104 (as shown in FIG. 10) may also include and/or be made of one or more microprocessors and/or nanoprocessors. Still further, the various aspects of the invention may be implemented by way of software and/or firmware program(s) that may be stored on suitable storage medium (e.g., computer-readable storage medium, hard drive, etc.) or media (such as floppy disk(s), memory chip(s), etc.) for transportability and/or distribution.

The present invention and/or one or more components thereof, and/or methods of using same, also may be used in conjunction with any suitable optical assembly including, but not limited to, optical assembly structures, interferometers, and/or retroreflectors such as those disclosed in U.S. Pat. Nos. 5,335,111; 5,949,543; 6,141,101; 6,473,185; 6,729,735; 6,752,503; 6,786,608; 6,827,455; 6,945,661; 7,168,817; 7,995,208; 8,092,030; 8,454,176; 8,567,968 to Bleier; U.S. Pat. No. 7,268,960 to Vishnia; U.S. Pat. Nos. 8,120,853; 8,205,852 and 8,205,853 to Jacobson et al.; and U.S. application Ser. No. 13/682,801, filed on Nov. 21, 2012, U.S. application Ser. No. 13/682,857, filed on Nov. 21, 2012, (presently pending), U.S. application Ser. No. 13/682,983, filed on Nov. 21, 2012, (presently pending), U.S. application Ser. No. 13/348,723, filed on Jan. 12, 2012, (presently pending), U.S. application Ser. No. 13/560,510, filed on Jul. 27, 2012, (presently pending), U.S. application Ser. No. 13/560,583, filed on Jul. 27, 2012, (presently pending), U.S. application Ser. No. 13/036,506, filed on Feb. 28, 2011, (presently pending), U.S. application Ser. No. 13/777,267, filed on Feb. 26, 2013 (presently pending), and U.S. application Ser. No. 13/965,333, filed on Aug. 13, 2013 (presently pending), each of which patents and applications are incorporated by reference herein in their entireties. One construction for a hollow retroreflector is as disclosed in U.S. Pat. No. 3,663,084 to Morton S. Lipkins.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A method of delivering or providing constant or substantially constant power, comprising dynamically controlling or changing at least one of a voltage and a current of a predetermined, electrical component such that an electrical power, which is at least one of provided or delivered to the predetermined component and consumed by the predetermined component, is at least one of: (i) identical or substantially similar to a predetermined, chosen or preset value of electrical power; and (ii) constant or substantially constant, thereby reducing, minimizing or eliminating power decay within the predetermined component.

2. The method of claim 1, wherein at least one of:
(i) the predetermined, electrical component has a resistance that operates to change over time, thereby requiring the dynamic control or change of at least one of the voltage and the current of the predetermined component to provide or deliver constant or substantially constant power;
(ii) the voltage of the predetermined, electrical component operates to be dynamic, varied or changed in response to the changing resistance of the predetermined, electrical component;
(iii) the voltage of the predetermined, electrical component is varied or changed using the equation V=square root (“sqrt”) of the product of power and resistance (P*R), where V is voltage, P is the predetermined, chosen or preset value of electrical power and R is the varying or changing resistance of the predetermined, electrical component;
(iv) the current of the predetermined, electrical component operates to be dynamic, varied or changed in response to the changing resistance of the predetermined, electrical component;
(v) the current of the predetermined, electrical component is varied or changed using the equation I=sqrt (P/R), where I is current, P is the predetermined, chosen or preset value of electrical power and R is the varying or changing resistance of the predetermined, electrical component;
(vi) the dynamically controlling or changing step further comprises changing only the voltage of the predetermined, electrical component while keeping the current of the predetermined, electrical component constant in response to the changing resistance of the predetermined, electrical component;
(vii) the dynamically controlling or changing step further comprises changing only the current of the predetermined, electrical component while keeping the voltage of the predetermined, electrical component constant in response to the changing resistance of the predetermined, electrical component;
(viii) the dynamically controlling or changing step further comprises changing a combination of the voltage of the predetermined, electrical component and the current of the predetermined, electrical component in response to the changing resistance of the predetermined, electrical component;
(ix) the resistance of the predetermined, electrical component changes as a function of the amount of time that the predetermined, electrical component is used or operated;
(x) the predetermined, electrical component comprises at least one of: a broadband thermal infrared source, a radiation source, an infrared source, a broadband light source, a light source that radiates on a broadband wavelength, a light source or device for producing a light beam, a thermal source, and a device for producing a radiation beam; and
(xi) the electrical power that is at least one of delivered to and consumed by the predetermined, electrical component originates from a power source.

3. The method of claim 2, further comprising:
(i) determining at least one of the electrical power at least one of consumed by and delivered or provided to the predetermined component and a value proportional to the electrical power at least one of consumed by and delivered or provided to the predetermined component by multiplying and obtaining a product of at least two signals, wherein: a first signal of the at least two signals at least one of represents and is proportional to the voltage of the predetermined component and a second signal of the at least two signals at least one of represents and is proportional to the current of the predetermined component;
(ii) comparing at least one of the determined at least one of consumed and delivered electrical power and the determined multiplication product representing the at least one of consumed and delivered electrical power with the predetermined, chosen or preset value of electrical power; and
(iii) adjusting, maintaining, creating or producing at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to the predetermined, chosen or preset value of electrical power; and constant or substantially constant.

4. The method of claim 3, wherein at least one of:
(i) the determining, comparing and adjusting, maintaining, creating or producing steps are performed in a closed-loop control circuit and/or system;
(ii) the determining, comparing and adjusting, maintaining, creating or producing steps are performed continuously and are repeated while the predetermined component is operating; and
(iii) the predetermined, chosen or preset value of electrical power is at least one of: a preset value of electrical power that the predetermined component consumes to operate; a preset value of electrical power that the predetermined component needs to operate; a value of electrical power that a user of the predetermined component has set for the predetermined component; a factory or manufactured setting of electrical power at which the predetermined component is designed to operate; and a value of electrical power to be constantly maintained and achieved for at least one of delivery to and use by the predetermined component.

5. The method of claim 4, further comprising at least one of:
(i) computing, calculating and/or creating at least one of:
(a) the voltage of the predetermined component;
(b) a voltage that is proportional to the electrical power that is at least one of consumed by and delivered to the predetermined component;
(c) the current of the predetermined component;
(d) a current that is proportional to the electrical power that is at least one of consumed by and delivered to the predetermined component;
(e) the first signal of the at least two signals; and
(f) the second signal of the at least two signals;
(ii) obtaining or receiving the predetermined, chosen or preset value of the electrical power from at least one of a processor and a database in connection with a circuit and/or system operating the method to deliver or provide the constant or substantially constant power to the predetermined component;
(iii) obtaining, receiving or setting the predetermined, chosen or preset value of the electrical power using a potentiometer (“pot”) of at least one of a circuit and a system operating the method to deliver or provide the constant or substantially constant power to the predetermined component;
(iv) determining at least one of:
(a) whether to increase, decrease or keep constant at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(b) if a need for an increase or decrease is determined, at least one of the amount of the increase or the decrease of at least one of: the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; and
(c) the final corrected value of at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(v) automatically adjusting, maintaining, creating or producing at least one of the voltage of the predetermined component, the current of the predetermined component, the voltage that is proportional to the electrical power that is at least one of consumed by and delivered to the predetermined component and the current that is proportional to the electrical power that is at least one of consumed by and delivered to the predetermined component in one or more increments, wherein the closed-loop operates to electrically perform the automatic maintenance, adjustment or production cyclically over time while the predetermined component is in operation; and
(vi) evaluating or sending at least one of the determined electrical power that is at least one of consumed by and delivered to the predetermined component, the at least two signals and the multiplication product to a control circuit or control system operating the method to deliver or provide the constant or substantially constant power to the predetermined component.

6. The method of claim 2, further comprising at least one of:
(i) measuring at least one of the voltage of the predetermined component and a signal proportional to the voltage of the predetermined component to obtain a first value;
(ii) measuring at least one of the current of the predetermined component and a signal proportional to the current of the predetermined component;
(iii) creating a voltage proportional to at least one of the current and the signal proportional to the current, the voltage proportional to at least one of the current and the signal proportional to the current having a second value;
(iv) multiplying and obtaining a product of at least one of the measured voltage and the measured current and the first and second values, thereby obtaining a value that is proportional to the at least one of consumed and delivered electrical power;
(v) comparing the determined value that is proportional to the at least one of consumed and delivered electrical power with the predetermined, chosen or preset value of electrical power; and
(vi) adjusting, maintaining, creating or producing at least one of the current, the voltage, both the current and the voltage, and the product of the voltage times current delivered to the predetermined electrical component such that the electrical power that is at least one of delivered to and consumed by the predetermined component is at least one of: identical or substantially similar to the predetermined, chosen or preset value of electrical power; and constant or substantially constant.

7. The method of claim 6, wherein at least one of:
(i) the measured at least one of the voltage of the predetermined component and the signal proportional to the voltage of the predetermined component is available or stored as a digital number;
(ii) the measured at least one of the current of the predetermined component and the signal proportional to the current of the predetermined component is available or stored as a second digital number;
(iii) the first and second values are converted to first and second digital numbers by at least one analog-to-digital converter (ADC);
(iv) the first and second digital numbers are multiplied using a digital multiplier, thereby obtaining a number that is proportional to the at least one of consumed and delivered electrical power;
(v) the digital multiplier is included in a computer or processor that operates to use the multiplied number output from the digital multiplier to perform a processing step for generating a digital-to-analog converter (DAC) command, the DAC command being transmitted to a DAC, which generates an analog output that is transmitted to a power stage, the power stage also receiving a commanded power from the processing step of the computer or processor and using the commanded power and the analog output from the DAC to perform the adjusting, maintaining, creating or producing step;
(vi) the measuring, measuring, creating, multiplying and adjusting, maintaining, creating or producing steps are performed by at least one of the computer or the processor and one or more processors or computers;
(vii) the measuring voltage step is performed by a voltage measuring circuit and the measuring current step is performed by a current measuring circuit;
(viii) the measuring, measuring, creating, multiplying and adjusting, maintaining, creating or producing steps are performed in a closed-loop circuit and/or system;
(ix) at least one of the computer or the processor and the one or more processors or computers executes the measuring, measuring, creating, multiplying and adjusting, maintaining, creating or producing steps by: (a) creating one or more new command numbers for one or more variables to be controlled, the one or more variables comprising at least one of: the current, the voltage, both the current and the voltage, and the product of the voltage times current delivered to the predetermined electrical component; and (b) applying the one or more new command numbers to one or more digitally responsive circuits, thereby controlling the one or more variables;
(x) the one or more digitally responsive circuits comprise digital-to-analog converters (DACs) that operate to create at least one of the output voltages and the output currents;
(xi) the signals that are proportional to at least one of the voltage, the current and the at least one of consumed and delivered electrical power are generated by at least one logarithmic amplifier and an antilogarithmic amplifier, the at least one logarithmic amplifier operating to generate a voltage proportional to log (the voltage of the predetermined component) and a voltage proportional to log (the current of the predetermined component) and to transmit the generated voltages to a summing amplifier, the summing amplifier operating to sum the two generated voltages, thereby creating a voltage proportional to the log of the current times the voltage, and the antilogarithmic amplifier operating to receive the voltage proportional to the log of the current times the voltage and to create a voltage proportional to the at least one of consumed and delivered electrical power;
(xii) the measuring, measuring, creating, multiplying and adjusting, maintaining, creating or producing steps are performed continuously and repeated while the predetermined component is operating; and
(xiii) the predetermined, chosen or preset value of electrical power is at least one of: a preset value of electrical power that the predetermined component consumes to operate; a preset value of electrical power that the predetermined component needs to operate; a value of electrical power that a user of the predetermined component has set for the predetermined component; a factory or manufactured setting of electrical power at which the predetermined component is designed to operate; and a value of electrical power to be constantly maintained and achieved for at least one of delivery to and use by the predetermined component.

8. The method of claim 7, further comprising at least one of:
(i) computing, calculating and/or creating at least one of:
(a) the voltage of the predetermined component;
(b) a voltage that is proportional to the electrical power that is at least one of consumed by and delivered to the predetermined component;
(c) the current of the predetermined component;
(d) a current that is proportional to the electrical power that is at least one of consumed by and delivered to the predetermined component;
(e) the first signal of the at least two signals; and
(f) the second signal of the at least two signals;
(ii) obtaining or receiving the predetermined, chosen or preset value of the electrical power from at least one of a processor and a database in connection with a circuit and/or system operating the method to deliver or provide the constant or substantially constant power to the predetermined component;
(iii) obtaining, receiving or setting the predetermined, chosen or preset value of the electrical power using a potentiometer (“pot”) of at least one of a circuit and a system operating the method to deliver or provide the constant or substantially constant power to the predetermined component;
(iv) determining at least one of:
(a) whether to increase, decrease or keep constant at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(b) if a need for an increase or decrease is determined, at least one of the amount of the increase or the decrease of at least one of: the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; and
(c) the final corrected value of at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(v) automatically adjusting, maintaining, creating or producing at least one of the voltage of the predetermined component, the current of the predetermined component, the voltage that is proportional to the electrical power that is at least one of consumed by and delivered to the predetermined component and the current that is proportional to the electrical power that is at least one of consumed by and delivered to the predetermined component in one or more increments, wherein the closed-loop operates to electrically perform the automatic maintenance, adjustment or production cyclically over time while the predetermined component is in operation; and
(vi) evaluating or sending at least one of the determined electrical power that is at least one of consumed by and delivered to the predetermined component, the at least two signals and the multiplication product to a control circuit or control system operating the method to deliver or provide the constant or substantially constant power to the predetermined component.

9. A power control circuit for delivering or providing constant or substantially constant power, comprising:
at least one of at least one circuit and at least one processor, at least one of the at least one circuit and the at least one processor operating to:
dynamically control or change at least one of a voltage and a current of a predetermined, electrical component such that an electrical power, which is at least one of provided or delivered to the predetermined component and consumed by the predetermined component, is at least one of: (i) identical or substantially similar to a predetermined, chosen or preset value of electrical power; and (ii) constant or substantially constant, thereby reducing, minimizing or eliminating power decay within the predetermined component.

10. The power control circuit of claim 9, wherein at least one of:
(i) the predetermined, electrical component is connected to, and communicates with, the at least one of the at least one circuit and the at least one processor;
(ii) the predetermined, electrical component operates such that a resistance thereof operates to change over time, thereby requiring the dynamic control or change of at least one of the voltage and the current of the predetermined component by at least one of the at least one circuit and the at least one processor for providing or delivering constant or substantially constant power;
(iii) the at least one of the at least one circuit and the at least one processor further operates to dynamically vary or change the voltage of the predetermined, electrical component in response to the changing resistance of the predetermined, electrical component;
(iv) the at least one of the at least one circuit and the at least one processor further operates to vary or change the voltage of the predetermined, electrical component using the equation V=square root (“sqrt”) of the product of power and resistance (P*R), where V is voltage, P is the predetermined, chosen or preset value of electrical power and R is the varying resistance of the predetermined, electrical component;
(v) the at least one of the at least one circuit and the at least one processor further operates to dynamically vary or change the current of the predetermined, electrical component in response to the changing resistance of the predetermined, electrical component;
(vi) the at least one of the at least one circuit and the at least one processor further operates to vary or change the current of the predetermined, electrical component using the equation I=sqrt (P/R), where I is current, P is the predetermined, chosen or preset value of electrical power and R is the varying resistance of the predetermined, electrical component;
(vii) the at least one of the at least one circuit and the at least one processor further operates to vary or change only the voltage of the predetermined, electrical component while keeping the current of the predetermined, electrical component constant in response to the changing resistance of the predetermined, electrical component;
(viii) the at least one of the at least one circuit and the at least one processor further operates to vary or change only the current of the predetermined, electrical component while keeping the voltage of the predetermined, electrical component constant in response to the changing resistance of the predetermined, electrical component;
(ix) the at least one of the at least one circuit and the at least one processor further operates to dynamically vary or change a combination of the voltage of the predetermined, electrical component and the current of the predetermined, electrical component in response to the changing resistance of the predetermined, electrical component;
(x) the resistance of the predetermined, electrical component changes as a function of the amount of time that the predetermined, electrical component is used or operated;
(xi) the predetermined, electrical component comprises at least one of: a broadband thermal infrared source, a radiation source, an infrared source, a broadband light source, a light source that radiates on a broadband wavelength, a light source or device for producing a light beam, a thermal source, and a device for producing a radiation beam;
(xii) the electrical power that is at least one of delivered to and consumed by the predetermined, electrical component originates from a power source operating to provide the electrical power; and
(xiii) the at least one of the at least one circuit and the at least one processor are connected to, and in communication with, the power source operating to provide the electrical power.

11. The power control circuit of claim 10, wherein the at least one of the at least one circuit and the at least one processor further operates to at least one of:
(a) at least one of:
(i) determine at least one of the electrical power at least one of consumed by and delivered or provided to the predetermined component and a value proportional to the electrical power by multiplying and obtaining a product of at least two signals, wherein: a first signal of the at least two signals at least one of represents and is proportional to the voltage of the predetermined component and a second signal of the at least two signals at least one of represents and is proportional to the current of the predetermined component;
(ii) compare at least one of the determined at least one of consumed and delivered electrical power and the determined multiplication product representing the at least one of consumed and delivered electrical power the predetermined, chosen or preset value of electrical power;
(iii) adjust, maintain, create or produce at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to the predetermined, chosen or preset value of electrical power; and constant or substantially constant;
(iv) automatically and continuously repeat limitations (a)(i), (a)(ii) and (a)(iii); and
(v) automatically and continuously repeat limitations (a)(i), (a)(ii) and (a)(iii) while the predetermined component is operational; and
(b) at least one of:
(i) measuring at least one of the voltage of the predetermined component and a signal proportional to the voltage of the predetermined component to obtain a first value;
(ii) measuring at least one of the current of the predetermined component and a signal proportional to the current of the predetermined component;
(iii) creating a voltage proportional to at least one of the current and the signal proportional to the current, the voltage proportional to at least one of the current and the signal proportional to the current having a second value;
(iv) multiplying and obtaining a product of at least one of the measured voltage and the measured current and the first and second values, thereby obtaining a value that is proportional to the at least one of consumed and delivered electrical power;
(v) comparing the determined value that is proportional to the at least one of consumed and delivered electrical power with the predetermined, chosen or preset value of electrical power;
(vi) adjusting, maintaining, creating or producing at least one of the current, the voltage, both the current and the voltage, and the product of the voltage times current delivered to the predetermined electrical component such that the electrical power that is at least one of delivered to and consumed by the predetermined component is at least one of: identical or substantially similar to the predetermined, chosen or preset value of electrical power; and constant or substantially constant;
(vii) automatically and continuously repeat limitations (b)(i) through (b)(vi); and
(viii) automatically and continuously repeat limitations (b)(i) through (b)(vi) while the predetermined component is operational.

12. The power control circuit of claim 11, wherein at least one of:
(i) the power control circuit operates in a closed-loop;
(ii) at least one of the at least one circuit and the at least one processor operate in a closed-loop;
(iii) the predetermined, chosen or preset value of electrical power is at least one of: a preset value of electrical power that the predetermined component consumes to operate; a preset value of electrical power that the predetermined component needs to operate; a value of electrical power that a user of the predetermined component has set for the predetermined component; a factory or manufactured setting of electrical power at which the predetermined component is designed to operate; a value of electrical power to be constantly maintained and achieved for at least one of delivery to and use by the predetermined component; set or modified locally with respect to the power control circuit; and set or modified remotely with respect to the power control circuit;
(iv) at least one of the at least one circuit and the at least one processor operate to at least one of receive and set a new value for the predetermined, chosen or preset value of electrical power;
(v) the measured at least one of the voltage of the predetermined component and the signal proportional to the voltage of the predetermined component is available or stored as a digital number;
(vi) the measured at least one of the current of the predetermined component and the signal proportional to the current of the predetermined component is available or stored as a second digital number;
(vii) the first and second values are converted to first and second digital numbers by an analog-to-digital converter (ADC);
(viii) the first and second digital numbers are multiplied using a digital multiplier, thereby obtaining a number that is proportional to the at least one of consumed and delivered electrical power;
(ix) the digital multiplier is included in the at least one of the at least one circuit and the at least one processor that further operates to use the multiplied number output from the digital multiplier to perform a processing function for generating a digital-to-analog converter (DAC) command, the DAC command being transmitted to a DAC, which generates an analog output that is transmitted to a power stage, the power stage also receiving a commanded power from the processing function of the at least one of the at least one circuit and the at least one processor and using the commanded power and the analog output from the DAC to perform the adjusting, maintaining, creating or producing function;
(x) the at least one of the at least one circuit and the at least one processor executes the measuring, measuring, creating, multiplying and adjusting, maintaining, creating or producing functions by: (a) creating one or more new command numbers for one or more variables to be controlled, the one or more variables comprising at least one of: the current, the voltage, both the current and the voltage, and the product of the voltage times current delivered to the predetermined electrical component; and (b) applying the one or more new command numbers to one or more digitally responsive circuits, thereby controlling the one or more variables;
(xi) the one or more digitally responsive circuits comprise digital-to-analog converters (DACs) that operate to create at least one of the output voltages and the output currents
(xii) the measuring voltage function is performed by a voltage measuring circuit of the power control circuit and the measuring current function is performed by a current measuring circuit of the power control circuit; and
(xiii) the signals that are proportional to at least one of the voltage, the current and the at least one of consumed and delivered electrical power are generated by at least one logarithmic amplifier and an antilogarithmic amplifier, the at least one logarithmic amplifier operating to generate a voltage proportional to log (the voltage of the predetermined component) and a voltage proportional to log (the current of the predetermined component) and to transmit the generated voltages to a summing amplifier, the summing amplifier operating to sum the two generated voltages, thereby creating a voltage proportional to the log of the current times the voltage, and the antilogarithmic amplifier operates to receive the voltage proportional to the log of the current times the voltage and to create a voltage proportional to the at least one of consumed and delivered electrical power.

13. The power control circuit of claim 12, wherein the at least one of the at least one circuit and the at least one processor further operates to at least one of:
(i) compute at least one of:
(a) the voltage of the predetermined component;
(b) a voltage that is proportional to the electrical power that is at least one of consumed by and delivered to the predetermined component;
(c) the current of the predetermined component;
(d) a current that is proportional to the electrical power that is at least one of consumed by and delivered to the predetermined component;
(e) the first signal of the at least two signals; and
(f) the second signal of the at least two signals;
(ii) obtain or receive the predetermined, chosen or preset value of the electrical power from at least one of a processor and a database connected to, and in communication with, the power control circuit;
(iii) obtain, receive or set the predetermined, chosen or preset value of the electrical power using a potentiometer (“pot”) that is connected to, and in communication with, the power control circuit;
(iv) determine at least one of:
(a) whether to increase, decrease or keep constant at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(b) if a need for an increase or decrease is determined, at least one of the amount of the increase or the decrease of at least one of: the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals; and
(c) the final corrected value of at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals;
(v) automatically adjust, maintain, create or produce at least one of the voltage of the predetermined component, the current of the predetermined component, the voltage that is proportional to the electrical power that is at least one of consumed by and delivered to the predetermined component and the current that is proportional to the electrical power that is at least one of consumed by and delivered to the predetermined component or automatically adjust at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals in one or more increments, wherein the closed-loop operates to electrically perform the automatic maintenance or adjustment cyclically over time while the predetermined component is in operation; and
(vi) evaluate or send at least one of the determined electrical power that is at least one of consumed by and delivered to the predetermined component, the at least two signals and the multiplication product when determining whether to increase, decrease or keep constant at least one of the voltage of the predetermined component, the current of the predetermined component, the voltage that is proportional to the electrical power that is at least one of consumed by and delivered to the predetermined component, the current that is proportional to the electrical power that is at least one of consumed by and delivered to the predetermined component, the first signal of the at least two signals and the second signal of the at least two signals.

14. The power control circuit of claim 13, wherein the at least one of the at least one circuit and the at least one processor further comprises at least one of a first circuit and a first processor and at least one of a second circuit and a second processor, wherein:
(i) the at least one of the first circuit and the first processor operates to determine the at least one of consumed and delivered electrical power, to receive the at least two signals, to calculate the value proportional to the electrical power by multiplying and obtaining a product of the at least two signals, and to send at least one of the at least two signals, the multiplication product and the calculated at least one of consumed and delivered electrical power to the at least one of the second circuit and the second processor; and
(ii) the at least one of the second circuit and the second processor operates to:
(a) compare at least one of the determined electrical power that is at least one of consumed and delivered to the predetermined component, the at least two signals, and the determined multiplication product representing the at least one of consumed and delivered electrical power with the predetermined, chosen or preset value of electrical power; and
(b) adjust, maintain, create or produce at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to a predetermined, chosen or preset value of power; and constant or substantially constant, thereby reducing, minimizing or eliminating power decay within the predetermined component.

15. The power control circuit of claim 14, wherein the at least one of the second circuit and the second processor further operates to at least one of: (i) automatically and continuously repeat the comparison of the information received from the at least one of the first circuit and the first processor and the adjustment, maintenance or production of the at least one of the voltage and current of the predetermined component; and (ii) automatically and continuously repeat the comparison of the information received from the at least one of the first circuit and the first processor and the adjustment, maintenance or production of the at least one of the voltage and current of the predetermined component while the predetermined component is operational.

16. The power control circuit of claim 15, wherein at least one of:
(i) the at least one of the at least one first circuit and the at least one first processor comprises at least one of: an integrated circuit, a MAX 4210B, a MAX 4210, a MAX 4211, a computer, one or more processors, one or more microprocessors, and one or more analog-to-digital converters with one or more analog conditioning circuits;
(ii) the at least one of the at least one second circuit and the at least one second processor comprises at least one of: an integrated circuit; a MAX15041, a switching regulator, and a closed-loop switching regulator, a computer, one or more processors and one or more microprocessors; and
(iii) the at least one of the second circuit and the second processor further comprises at least one closed-loop switching regulator to produce at least one of the varied or changed voltage and the varied or changed current to operate the predetermined component.

17. The power control circuit of claim 16, wherein the switching regulator or the at least one closed-loop switching regulator comprises a first regulator and a second regulator, the first regulator operating to produce the varied or changed voltage and the second regulator operating to produce the varied or changed current.

18. The power control circuit of claim 17, wherein at least one of:
(i) the first regulator is at least one of: a voltage regulator, a voltage switching regulator, a voltage regulator with an operational amplifier (“op amp”), a transistor regulator, silicon controlled rectifiers (“SCR”), a voltage stabilizer and the MAX15041;
(ii) the first regulator operates to employ synchronous DC-DC conversion to achieve efficiency over a wide range of output voltages and/or currents of the predetermined component;
(iii) the second regulator is at least one of: a transistor, a current regulator, an operational amplifier (“op amp”), a field-effect transistor, a junction gate field-effect transistor (“JFET”), a current source, a current source with thermal compensation, a voltage regulator current source, and the MAX15041;
(iv) the first regulator, the second regulator and the pot are connected to, and in communication with, the predetermined component;
(v) the pot comprises a three-terminal resistor with a sliding contact that operates as a voltage divider to be used to set the predetermined power value for the predetermined component; and
(vi) the pot operates to set or modify the predetermined, chosen or preset value of electrical power.

19. The power control circuit of claim 18, further comprising at least one of:
(i) one or more analog-to-digital converters operating to convert at least one of the at least two signals, the multiplication product and the information from analog and digital; and one or more digital-to-analog converters operating to convert at least one of the at least two signals, the multiplication product and the information from digital to analog;
(ii) one or more analog-to-digital converters and one or more digital-to-analog converters when one or more of the computers are in use, such that the one or more of the computers operate to sense current and/or voltage of the predetermined component with the one or more analog-to-digital converters and to provide at least one of command voltage and current to the switching regulator with the one or more digital-to-analog converters; and
(iii) at least one of: a printed circuit board (“PCB”) or a prototype board; one or more capacitors; at least one inductor; at least one resistor; one or more additional voltage regulators; one or more additional current regulators; at least one snubbing network; one or more pads for use with the at least one snubbing network, the at least one resistor and the one or more capacitors; at least one of a 78L05 voltage regulator and regulator or transistor using a T0-92 structure; and a loop compensation network.

20. The power control circuit of claim 19, further comprising a predetermined path for the at least one of consumed and delivered electrical power to travel through the power control circuit, a first ground connection running under the PCB or the prototype board and a second ground connection running next to the power path, wherein the power path is straight and direct or substantially straight and substantially direct over the structure of the PCB or the prototype board, the first and second ground connections are disposed at the extended paddle (“EP”) under the at least one of the at least one second circuit and the at least one second processor and the EP operates to conduct heat.

21. The power control circuit of claim 20, wherein: (i) the one or more capacitors comprise at least six capacitors; (ii) the at least one inductor comprises at least one of a 47 uH inductor, a 100 uH inductor, a 39 uH inductor, a Digi-Key 587-1700-1-ND, an inductor having an inductance in the range of about 39 uH to about 100 uH; and (iii) the at least one resistor comprises at least one of a 0.091 Ohm resistor and a Digi-Key RL16R.091FCT-ND.

22. The power control circuit of claim 21, further comprising at least one of at least one power regulator and one or more power sensors, the one or more power sensors operating to confirm that the electrical power being at least one of delivered to and consumed by the predetermined component is remaining constant or substantially constant.

23. A Fourier Spectrometer comprising:
a Fourier modulator including a Michelson interferometer;
a broadband and/or thermal light source collimated by a first optical system and incident on the Michelson interferometer therein;
a second optical system collecting light transmitted by the Michelson interferometer and transmitting it to a sample region;
a third optical system collecting light from the sample region and focusing it into a detector region;
an optical detector located in the detector region converting the transmitted light from the sample region into an electrical signal;
a power control circuit of any of claims 9 to 22 operating to stabilize the broadband and/or thermal light source by delivering or providing a constant or substantially constant power to the broadband and/or thermal light source; and
a Fourier analyzer comprising one or more electronics and software that operate to convert the electrical signal into an optical spectrum.

24. A non-transitory computer-readable storage medium containing software code operating to cause one or more of a plurality of processors to perform the steps, comprising:
dynamically controlling or changing at least one of a voltage and a current of a predetermined, electrical component such that an electrical power, which is at least one of provided or delivered to the predetermined component and consumed by the predetermined component, is at least one of: (i) identical or substantially similar to a predetermined, chosen or preset value of power; and (ii) constant or substantially constant, thereby reducing, minimizing or eliminating power decay within the predetermined component;
receiving or determining at least one of the electrical power at least one of consumed by and delivered or provided to the predetermined component and a value proportional to the electrical power by multiplying and obtaining a product of at least two signals, wherein: a first signal of the at least two signals at least one of represents and is proportional to the voltage of the predetermined component and a second signal of the at least two signals at least one of represents and is proportional to the current of the predetermined component;
comparing at least one of the determined electrical power and the determined multiplication product representing the at least one of consumed and delivered electrical power with the predetermined, chosen or preset value of electrical power; and
adjusting, maintaining, creating or producing at least one of the voltage and current of the predetermined component based on at least one of the at least two signals, the multiplication product and the predetermined, chosen or preset value of electrical power such that the electrical power that is at least one of delivered to and consumed by the predetermined component is at least one of: identical or substantially similar to the predetermined, chosen or preset value of electrical power; and constant or substantially constant, wherein at least one of:
(i) the predetermined, electrical component has a resistance that operates to change over time, thereby requiring the dynamic control or change of at least one of the voltage and the current of the predetermined component to provide or deliver constant or substantially constant power;
(ii) the voltage of the predetermined, electrical component operates to be dynamic, varied or changed in response to the changing resistance of the predetermined, electrical component;
(iii) the voltage of the predetermined, electrical component is varied or changed using the equation V=square root (“sqrt”) of the product of power and resistance (P*R), where V is voltage, P is the predetermined, chosen or preset value of electrical power and R is the varying or changing resistance of the predetermined, electrical component;
(iv) the current of the predetermined, electrical component operates to be dynamic, varied or changed in response to the changing resistance of the predetermined, electrical component;
(v) the current of the predetermined, electrical component is varied or changed using the equation I=sqrt (P/R), where I is current, P is the predetermined, chosen or preset value of electrical power and R is the varying or changing resistance of the predetermined, electrical component;
(vi) the dynamically controlling or changing step further comprises changing only the voltage of the predetermined, electrical component while keeping the current of the predetermined, electrical component constant in response to the changing resistance of the predetermined, electrical component;
(vii) the dynamically controlling or changing step further comprises changing only the current of the predetermined, electrical component while keeping the voltage of the predetermined, electrical component constant in response to the changing resistance of the predetermined, electrical component;
(viii) the dynamically controlling or changing step further comprises changing a combination of the voltage of the predetermined, electrical component and the current of the predetermined, electrical component in response to the changing resistance of the predetermined, electrical component;
(ix) the resistance of the predetermined, electrical component changes as a function of the amount of time that the predetermined, electrical component is used or operated;
(x) the predetermined, electrical component comprises at least one of: a broadband thermal infrared source, a radiation source, an infrared source, a broadband light source, a light source that radiates on a broadband wavelength, a light source or device for producing a light beam, a thermal source, and a device for producing a radiation beam; and
(xi) the electrical power that is at least one of delivered to and consumed by the predetermined, electrical component originates from a power source.
